(19) United States
(12) Patent Application Publication
(10) Pub. No.: US 2009/0243159 A1
(43) Pub. Date: Oct. 1, 2009

(54) Method for thermal crosslinking of previously irradiated polymeric material and medical implant

(76) Inventor: Dehchuan Sun, Taipei City (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/076,969

(22) Filed: Mar. 26, 2008

(51) Int. Cl. B29C 35/08

(52) U.S. Cl. 264/494; 264/234

(57) ABSTRACT

A method for forming a crosslinked oxidation-resistant toughness-enhanced polymeric material includes the steps of placing a previously irradiated polymer material in a heating device under oxygen-reduced atmosphere at a temperature above the melting point of the polymeric material for a sufficient time to (a) eliminate oxidation in the polymeric material, (b) break existing crosslinks into free radicals, (c) migrate and re-distribute radiation-induced free radicals in an uniform manner, (d) create new free radicals by thermal energy and form uniform crosslinks within the polymer micro-structure, and followed by a cooling step to eliminate residual free radicals and form additional uniform crosslinks within the polymer micro-structure. A method of making a crosslinked oxidation-resistant toughness-enhanced wear-reduced UHMWPE medical implant from a previously irradiated solid form of UHMWPE is also disclosed.

### BACKGROUND OF THE INVENTION

1. Field of the Invention

This invention is an improvement of methods disclosed in U.S. patent application Ser. No. 11/463,423 and relates to oxidation-resistant crosslinked polymeric material in general. More specifically, the invention relates to thermally crosslinked medical implants formed of a previously irradiated polymeric material, such as polyethylene or more specifically ultra high molecular weight polyethylene (UHMWPE), with enhanced crosslinking, oxidation resistance, wear resistance, and toughness, and methods for making the same.

2. Description of Prior Art

The U.S. patent application Ser. No. 11/463,423 disclosed a thermal crosslinking method comprising specific heating and cooling steps for producing a polymeric material having significant crosslinking and improved oxidation resistance. It also disclosed thermal crosslinking methods for producing medical implants made from an olefinic polymer (in either resin powder or consolidated form) with improved oxidation and wear resistance while maintaining or enhancing toughness. In its disclosure, U.S. patent application Ser. No. 11/463,423 described the definition of ultra high molecular weight polyethylene (UHMWPE) and its clinical use in joint replacements (such as hips or knees). The application discussed the unique physical and chemical properties of UHMWPE that lead to superior chemical and wear resistance while providing high toughness. The application discussed a common practice by implant manufacturers in which finished UHMWPE products are subjected to gamma radiation for sterilization. The application also discussed the use of gamma or electron beam radiation by manufacturers to induce crosslinking in UHMWPE for wear resistance improvement. The application further discussed the two major drawbacks caused by radiation, namely adverse material property changes and oxidation-induced chain scission. It is obvious that a previously irradiated material can be used as a starting material for thermal crosslinking treatments disclosed in the U.S. patent application Ser. No. 11/463,423. The application, however, did not explicitly describe the state of the starting material regarding irradiation. The inventor discovered that the thermal crosslinking methods disclosed in the U.S. patent application Ser. No. 11/463,423 can further improve material properties of a previously irradiated polymeric material. The inventor discovered further that unique material properties can be obtained using a combination of radiation-induced and thermally induced crosslinking. Still, the inventor discovered that oxygen reduced (or inert) atmosphere that is used in several prior arts (such as U.S. Pat. Nos. 5,414,049, 5,879,400, 6,017,975, 6,228,900, 6,245,276, 6,800,670, 6,818,172, 6,849,224, 6,852,772) during polymer resin powder and/or radiation treatments for prevention of oxidation is no longer a required process condition, thanks to the oxidation elimination and material property recovery method disclosed in this application. For instance, in U.S. Pat. No. 5,414,049, the inventors disclosed a method whereby oxygen contained in the resin powder of UHMWPE is removed by various means prior to the consolidation process in order to avoid oxidation. It also taught to conduct the radiation treatment and the subsequent annealing step in an oxygen reduced atmosphere to prevent oxidation. The patent did not teach a method to remove existing oxidation from the material. U.S. Pat. No. 6,800,670 disclosed a method whereby a polymer is irradiated with gamma rays in air, then thermally treated (re-melting or annealing) in air, and followed by the removal of its most oxidized surface layer. It did not teach a method for oxidation elimination in the material or restoration of lost material property. Rather, it taught to remove the oxidized material from practical use. U.S. Pat. No. 6,448,315 disclosed a method for incorporating vitamin E, an anti-oxidant, into UHMWPE implants for prevention of oxidation. In this and other prior arts using a free radical scavenger in the polymer matrix, the inventors taught methods to prevent oxidation from occurring, rather than methods for elimination of existing oxidation. None of any prior art, listed here or not, teaches a method to eliminate oxidation or restore material property adversely affected by oxidation. Neither in any prior art teaches a method that improves or restores material property via re-distribution of crosslinks in a polymeric material adversely affected by radiation. Neither in any prior art teaches a method that reconnects broken short chains produced by radiation with unbroken long polymer molecules for improved material property. Furthermore, neither in any prior art teaches a method where unique material properties can be obtained by combining radiation and thermal crosslinking.

### SUMMARY OF THE INVENTION

The present invention, as an improvement of U.S. patent application Ser. No. 11/463,423, relates to a method for providing a polymeric material with enhanced crosslinking, superior oxidation resistance, improved mechanical property, and high wear resistance. More specifically, the invention relates to medical implants formed of a polymeric material, such as polyethylene or more specifically ultra high molecular weight polyethylene (UHMWPE), with significant crosslinking, improved oxidation resistance, toughness, and wear.

The inventor discovered that the thermal crosslinking methods disclosed in the U.S. patent application Ser. No. 11/463,423 can further improve material properties of a previously irradiated polymeric material. Further investigation concluded that the material improvement is realized through five distinct mechanisms, namely (1) elimination of oxidation, (2) breakage of existing crosslinks induced by radiation, (3) free radical and crosslink re-distribution, (4) re-connection of broken short chains, and (5) formation of thermally induced free radicals and crosslinks. Furthermore, the inventor discovered that oxygen reduced (or inert) atmosphere that is used in several prior arts (such as U.S. Pat. Nos. 5,414,049, 5,879,400, 6,017,975, 6,228,900, 6,245,276, 6,800,670, 6,818,172, 6,849,224, 6,852,772) during polymer resin powder and/or radiation treatments for prevention of oxidation is no longer a required process condition, thanks to the oxidation elimination and material property recovery method disclosed in this application. Still, the inventor discovered that there is a fundamental difference in molecular structure between radiation-induced and thermal-induced crosslinking. Radiation-induced crosslinking consists of primarily side-to-side or side-to-end chemical crosslinking between neighboring chains, while thermal crosslinking consists of primarily inter-locked molecular rings, and is physical crosslinking in nature. The inventor further discovered that chemical crosslinking can be obtained by using thermal force with the help of an oxidizing agent. Still, the inventor discovered that unique material properties can be obtained using a combination of radiation-induced and thermally induced crosslinking.

It is therefore an object of the invention to provide a polymeric material and a medical implant made from such material having significant crosslinking, superior oxidation resistance, enhanced mechanical property, and improved wear resistance by thermal crosslinking using a previously irradiated polymer as a staring material.

Implant material manufacturers often convert polymer resin powder into rods, slabs, blocks, or other solid forms using extrusion, compression molding, or other solid forming processes. Machining, drilling, patterning, assembling, and other fabrication steps are subsequently employed by implant manufacturers to obtain the final dimensions of the product. It is therefore another object of the invention to provide a method for manufacturing such polymeric medical implants having significant crosslinks, superior oxidation resistance, enhanced mechanical property, and improved wear resistance by thermal crosslinking using a previously irradiated polymer (resin powder or consolidated form) as a staring material.

Another common process used by implant manufacturers is to convert the polymer resin powder into near-finished or finished products using compression molding in a single step. It is therefore another object of the invention to provide a method for compression molding such polymeric implants having significant crosslinking, superior oxidation resistance, enhanced mechanical property, and improved wear resistance by thermal crosslinking steps using a previously irradiated polymer resin powder as a staring material.

Material or implant manufacturers often dispose materials or products containing oxidation. However, these materials or products can be reused if oxidation can be eliminated. It is therefore another object of the invention to provide a method for removing oxidation from such defected materials or products and for restoring material property and usefulness.

Material and implant manufacturers often use radiation or chemical crosslinking agents to induce chemical crosslinking in the material or product. However, chemical crosslinking can be obtained using an oven with the help of room air or an oxidizing agent. It is therefore another object of the invention to provide a method for creating chemical crosslinking in such materials or products using thermal force with the help of an oxidizing agent.

The above and other objects, features and advantages of the present invention will be better understood from the following specification in conjunction is with the accompanying examples.

### BRIEF DESCRIPTIONS OF THE DRAWINGS

FIG. 1 shows oxidation reaction mechanism.

FIG. 2 shows reaction mechanism in oxidation elimination.

FIG. 3 shows breakage of existing crosslinks and free radical and crosslink re-distribution in irradiated polymer.

FIG. 4 shows short chains re-connection with long chains in irradiated polymer.

FIG. 5 shows molecular configuration of radiation- and thermal-induced crosslinking.

FIG. 6 shows reaction mechanisms for formation of (a) broken chain segments, (b) long polymer chains without chain entanglements, (c) long polymer chains with chain entanglement, and (d) individual and inter-locked molecular rings.

FIG. 7 shows chemical reactions for creation of chemical crosslinking without radiation.

FIGS. 8A & 8B are photos of tibial insert (a) before treatment (b) after treatment.

FIGS. 9A & 9B are DSC melting curves for the tibial insert (a) before treatment (b) after treatment.

FIGS. 10A & 10B are load-extension curves for UHMWPE gamma irradiated at 50 KGY and shelf aged for 13 months (before and after treatment).

FIG. 11 shows wear loss vs. test cycle for crosslinked UHMWPE.

### DETAILED DESCRIPTION OF THE PREFERRED EMBODIMENTS

For the purpose of illustration, polyethylene or UHMWPE will be used as an example to describe the invention. However, all the theories and processes described hereafter are applicable to other polymeric materials with thermally stable backbone and side groups (as manifested by a higher degradation temperature than the melting point of the polymeric material), such as polypropylene, polyester (including polylactic acid and polyglycolic acid), Poly(methyl methacrylate) and nylon, unless otherwise stated.

### Elimination of Oxidation

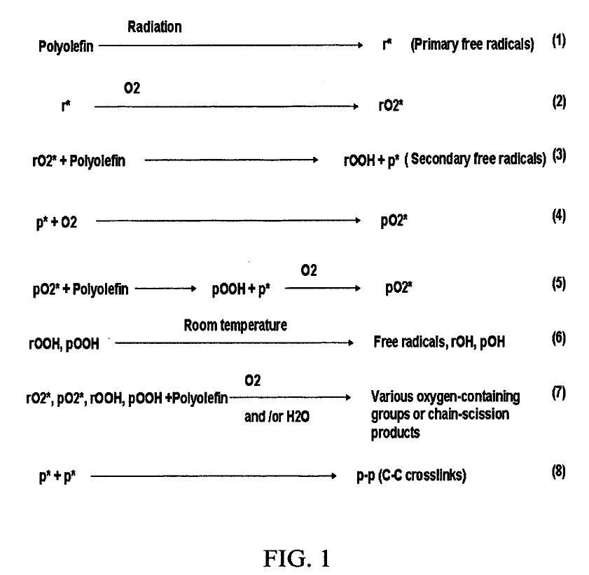

The inventor first discovered that oxidation in a polymeric material can be eliminated with lost material properties restored. UHMWPE is employed as an illustration for the discussion on the origin of oxidation and how oxidation can be eliminated. Resin powder of UHMWPE, the starting material, is in general free of oxidation as produced by chemical synthesis. However, resin power is known to contain significant amount of air, a source of oxygen for oxidation. During the resin consolidation process, such as ram extrusion or compression molding where the powder is converted into a solid form (rods, slabs, and other product shapes), oxidation is introduced in the material due to mechanical deformation under high temperature and high stress conditions. It has been observed that the surface layer suffers more oxidation than the core region in a solid product obtained from the consolidation process, owing to more severe conditions at the surface (higher mechanical forces, higher temperature, and higher oxygen concentration). In order to improve wear resistance, some manufacturers subject the consolidated solid material to a crosslinking treatment using gamma or electron beam radiation under air or other oxidizing atmospheres during which more oxidation is introduced. Other manufacturers conduct the radiation crosslinking treatment in an inert atmosphere. Still, the entrapped air in the material will cause oxidation, albeit at a reduced level compared to one conducted in air. During gamma or electron beam sterilization of finished products (normally packaged in air), the polymeric material is further oxidized. Even if the finished products are packed in an inert, vacuum, or oxygen reduced atmosphere as recently adopted by some implant manufacturers, oxidation can still occur if the package seal is failed. During warehouse and hospital storage, oxidation proceeds as long as oxidizing species are present in the package, or free radicals are present in the material. Finally, oxidative reactions continue to occur in vivo in the presence of oxidizing compounds and water. Before disclosing a new method for oxidation elimination, it is appropriate to review principal oxidative reactions and mechanisms which are well known to scientific community (see for example “Radiation Effects on Polymers”, book edited by Roger I. Claugh and Shalaby W. Shalaby, and published by American Chemical Society, Washington, D.C., 1991). The first step for oxidative reactions is the formation of free radicals in UHMWPE through breakage of C—C bond or C—H bond by radiation. Carbon free radicals then react with oxygen in subsequent chain reactions forming various oxygen-containing groups, as shown in equations (1) through (8) of FIG. 1.

It is noted again in the above equations that oxidation can occur during irradiation or post-radiation storage at room temperature. In a particular note, oxidation products (represented by rOOH and pOOH) can decompose at room temperature to produce new free radicals (equation (6)). In addition to oxygen, moisture present in air or in vivo may join oxidative reactions. As a result, a variety of oxygen-containing functional groups, including peroxides, esters, alcohols, aldehydes, and carbonic acids, can be produced (equations (6) and (7)). In general, these oxygen-containing groups are weaker than CH2-CH2 bonding in the original UHMWPE in terms of chemical bonding strength, causing oxidized UHMWPE to exhibit inferior material properties. Furthermore, through free radical transfer in oxygen-containing groups, C—C bonds are broken during storage to form chain-scission products (equation (7)). Chain scission, equivalent to molecular weight degradation, brings down toughness and wear resistance in UHMWPE. Since oxygen and moisture permeates through the amorphous regions in UHMWPE much more readily than the crystalline regions, the oxidative attack occurs primarily in the amorphous regions where tie molecules are located. Note that it is these tie molecules that make UHMWPE tough and wear resistant. In the development of the oxidation elimination method, the inventor discovered that elimination of oxidation in the amorphous regions alone may not restore the lost material property on a long term basis, due to the fact that free radicals in the crystalline regions can migrate out and into the amorphous regions, producing new oxidized material. From these findings, the inventor has derived a theory that if oxidation in a polymeric material is to be eliminated on a long term basis, two specific conditions must be met, namely (1) no free radicals exist throughout the entire material, including both crystalline and amorphous regions, and (2) no oxidation products exist in the material.

The inventor has discovered a practical means for oxidation elimination to meet these two conditions. As a result, the lost material property due to oxidation is regained.

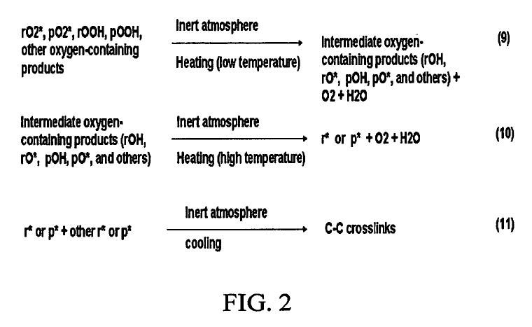

The method can be described by the equations (9) and (11) of FIG. 2.

In the first step, the oxidized polymeric material is placed in a heating chamber (container) with an inert atmosphere and a means for released gas products to escape. A practical example of such equipment is a convection oven flushed continuously with nitrogen. Another practical example is a vacuum oven with continuous suction. The oven temperature is raised past the melting point of the polymeric material (about 130 to 140 degree C. for UHMWPE) to a temperature sufficiently high to break all C—O bonds. A gradual temperature rise is preferred for obtaining a uniform temperature distribution. During the initial stage of temperature ramp-up, oxygen-containing compounds in the material with a relatively lower thermal stability (such as rOOH or pOOH, the peroxides) will decompose first, producing intermediate oxygen-containing compounds (such as rOH, rO*, pOH, or pO*) and releasing O2 and H2O gases (equation (9)). As the oven temperature rises well above the melting point (such as at about 200 degree C. or higher), thermal energy is strong enough to start breaking C—O bonds, removing eventually all oxygen from the material, and releasing more oxygen and water into the atmosphere (equation (10)). It is noted that gas products are removed continuously by the convective flow (or vacuum suction) provided by the oven in order to maintain high levels of oxygen and moisture concentration gradients, conditions required for effective gas diffusion-out. The inventor discovered that de-oxygen reactions (equations (9) and (10)) take a longer time to complete (up to several hours) for a larger rod or thicker slab, due to heat transfer and gas diffusion constraints. In the initial temperature ramp-up (from room temperature to about 200 degree C.), it is acceptable to use air circulation (rather than inert gas or vacuum suction) in the oven to save cost without affecting greatly the efficiency of oxygen removal. However, inert gas circulation or vacuum suction must be used in the later stage of the heating step to remove all oxygen in the material. It is a preferred condition to hold the oven temperature at a constant value (such as 250 degree C.) during the later stage of the heating step until oxygen is completely removed. For industrial consideration, it is often acceptable to leave hard-to-remove oxygen-containing species (such as C═O compounds) in the material to save time and heating cost. These compounds normally exist in a very small amount and are chemically stable under storage conditions (between room temperature and 50 degree C. in the presence of air and moisture). They are not expected to initiate free radical chain reactions (equations (1) through (8)) during storage or in vivo. The inventor often referred to bond energy as a guide during the method development. The associated bond energies with C—O, C—C, and C—H bonds are in the neighborhoods of 78, 80, and 98 kcal, respectively. Thus, C—O bonds are relatively weaker and will break at a lower temperature than C—C bonds. C—H bonds are much stronger and hardly broken during this heat treatment step, as observed by the inventor. The inventor discovered that there is a temperature range in which C—O and C—C bonds break simultaneously. For UHMWPE, the range is in the neighborhood of 160 to 400 degree C. In this range, free radicals and oxygen-containing compounds produced by radiation and post-radiation chain reactions (equations (1) through (7)) are transformed into carbon free radicals and become oxygen free (equation (10)). In the meantime, new free radicals are formed as a result of C—C bond breakage by thermal energy (the associated theories and mechanisms are disclosed in the U.S. patent application Ser. No. 11/463,423). Beyond about 400 degree C., the reaction rate for C—C bond breakage occurs so rapidly that material deterioration accompanied by vigorous gas release and weight loss becomes undesirable (see U.S. patent application Ser. No. 11/463,423).

After this heating step, the material is virtually oxidation free but still contains highly reactive carbon (mostly alkyl) free radicals (equation (10)). In the second step of the oxidation elimination method, a cooling means is provided in the oven under an inert atmosphere to bring the oven temperature down to a temperature below the crystallization temperature range of the polymer (such as between 80 and 120 degree C. for UHMWPE) and then down to room temperature. During cooling, carbon free radicals, including those created by radiation, post-radiation chain reactions, and thermal energy, react with each other to form C—C crosslinks (equation (11)). Also, during cooling, the polymer re-crystallizes into a solid. The polymer solid now contains neither free radicals is nor oxygen-containing compounds and thus will maintain oxidation free on a long term basis. Crystallinity or density (closely related), often seen increased in an oxidized polymer, is now restored to a level close to that of the virgin material before oxidation (also see the discussion on “Re-connection of broken short chains” later). Mechanical properties, often seen decreased in an oxidized polymer, are also restored or enhanced. The inventor further discovered that the crystallinity and the density of the resultant solid material can be varied to some extent by using a different cooling rate within the crystallization temperature range, just like the behavior of a virgin polymer, as disclosed in U.S. patent application Ser. No. 11/463,423. For instance, quenching by liquid nitrogen through the crystallization zone may result in a crystallinity as low as about 40%, while up to about 55% of crystallinity can be obtained using natural cooling in a static oven (vacuum sealed and no gas flow). However, the high end of this range (about 55%) is in general lower than that of a corresponding oxidized polymer (up to 65% or higher). As discussed, oxidation elimination is often accompanied by formation of new free radicals and crosslinks induced by thermal force, due to the overlap of the temperature range where these two mechanisms operate. As will be explained shortly, these new crosslinks contribute positively to the molecular structure and the material property of the polymer.

### Breakage of Existing Crosslinks Followed by Free Radical and Crosslink Re-Distribution

The inventor also discovered that (1) existing crosslinks in an irradiated polymeric material can be broken into free radicals, and (2) the newly produced free radicals, along with existing free radicals (those that are not crosslinked) are then re-distributed and form new crosslinks in a uniform manner. Due to these treatments, material properties are restored or enhanced. As discussed earlier, free radicals are produced during radiation by C—H (primary) and C—C (secondary) bond breakages and during post-radiation storage via a series of oxidative chain reactions (equations (1) through (7)). Some free radicals will react with each other during radiation to form C—C crosslinks (equation (8)), but the majority of them remain as reactive free radicals in the material. As discussed earlier, some prior arts taught methods to anneal an irradiated polymer in order to reduce or completely eliminate free radicals. During annealing, new C—C crosslinks are formed (equation (8)). A review of industrial applications shows that annealing temperature varies from 50 to 120 degree C. (see for example U.S. Pat. No. 5,414,049; also see “Advances in “Oxidation Resistance of 2^{nd} Generation UHMWPE”, Orhun K. Muratoglu, 3^{rd} UHMWPE International Meeting, Madrid, Spain, Sep. 14-15, 2007). It is noted that these prior arts all observed an improved wear resistance at the expense of tensile and fracture toughness properties upon radiation and annealing. Some other prior arts remelted irradiated UHMWPE to remove all free radicals but observed inferior material properties (lower tensile modulus, yield strength and ultimate strength) (see for example Kurtz, S. M., Villarraga, M. L., Herr, M. P., et al.: Biomaterials (2002) 23:3681). Still, others used an annealing temperature close to but below the melting point of UHMWPE to eliminate the majority of free radicals, then supplemented the annealing method with doped vitamin E (a free radical scavenger) to fend off further oxidation (see for example Oral, E., Christensen, S. D., Malhi, A. S., et al.: J. Arthroplasty (2006) 21:580). Still, others used incremental, sequential radiation and annealing treatments (instead of a one-step full dose radiation followed by a single annealing treatment) and observed some improvement in resultant material properties compared to a one-step method (see for example “Sequential annealed polyethylene”, A. Wang, 3^{rd} UHMWPE International Meeting, Madrid, Spain, Sep. 14-15, 2007). Several literature reports discussed the difference in material property and the origin of the property difference between annealing and remelting of an irradiated UHMWPE, but a general consensus is not yet reached (see for example in “On Mechanical Properties of UHMWPE”, Clare Rimnac, 3^{rd} UHMWPE International Meeting, Madrid, Spain, Sep. 14-15, 2007). The inventor theorized that a significant factor for the observed mechanical property decline in irradiated polymeric material is un-even distribution of C—C crosslinks. In U.S. patent application Ser. No. 11/463,423, the inventor discussed non-uniformity of crosslinking in an irradiated polymeric material in general. This subject is now discussed in great detail. It is well known that an electron beam has limited penetration power and often produces non-uniform crosslinking in thick parts. The surface zone receives a higher dose, generating more free radicals and thus containing more crosslinks than the interior. Penetration power of gamma rays is adequate for most industrial applications, but crosslinking is still non-uniform due to a radiation dose distribution across the thickness (see for example in “Radiation Effects on Polymers,” American Chemical Society, 1991 (Symposium of Aug. 26-31, 1990); and in “D. C. Sun, G. Schmidig, C. Stark, J. H. Dumbleton, “On the Origins of a Subsurface Oxidation Maximum and Its Relationship to the Performance of UHMWPE Implants”, 21th Annual Meeting of the Society For Biomaterials, page 362, 1995, San Francisco, Calif.). The radiation dose is lower at surface of a polymer, rising to a maximum at about 2-10 mm in depth (depending on material density, radiation source, etc.), and drops gradually to a minimum towards the core. As a result, the distributions of free radicals and crosslinks follow this pattern closely. Besides these macroscopic factors, there are two aspects of non-uniformity on the micro-structural level. First, crystalline regions tend to receive a higher dose than amorphous regions due to a higher density. Secondly, gamma rays (or electron beams) are discrete high energy “photons” (or electrons), rather than a continuous and homogeneous “field”. As a result, free radicals are formed in the material along the original path of photons, the path of photons after Compton scattering, and the path of secondary electrons (i.e. ionization zones). Upon annealing or remelting, crosslink formation also follows these paths closely. As a result, the distribution of crosslinks is highly non-uniform on the molecular level. For instance, one could picture to examine a specific UHMWPE molecule in the material after gamma radiation. There would be some carbons that have lost a hydrogen atom and become alkyl free radicals along the backbone. The spacing between two neighbored alkyl free radicals would vary widely (in terms of number of carbons or actual distance; note that a single bond length of C—C is about 154 pico-meter or 1.54*10⁻¹² meter). Furthermore, one could picture to examine crosslinking density of a small domain in the material (whose size is in the order of hundreds of C—C lengths, or about 10⁻¹⁰ meter, for instance). The crosslinking density would vary greatly from domain to domain, even though on average the crosslinking density in a gamma irradiated UHMWPE ranges from “1 crosslink in 500 carbon atoms” to “1 crosslink in 1500 carbon atoms”, depending on the radiation dose and post-radiation treatments (see for example National Institutes of Standards & Technology (NIST), Report of Investigation, Reference Material 8457, Ultra High Molecular Weight Polyethylene), Issue date Jul. 15, 2003). In summary, an irradiated polymer is non-uniform in crosslinking both macroscopically and microscopically. Upon mechanical deformation (such as tensile, compressive, fracture, or wear test), micro-separation and chain scission will occur first in the non-crosslinked (relatively weaker) regions of the material. Thus, it is primarily the strength of non-crosslinked regions that determines the ultimate property of the material. It thus follows that a strong contrast in material strength within the microstructure (weak vs. strong), such as one created by non-uniform crosslinking, is non-ideal for achieving superior material property.

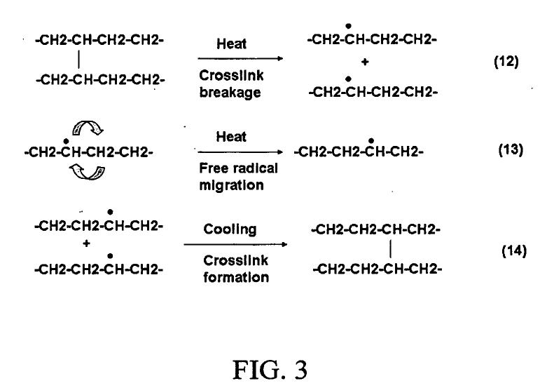

The inventor discovered a method to obtain uniform crosslinking in an irradiated polymer. The method can be described by equations (12) through (14) in FIG. 3 shown below. First, the irradiated polymer is placed in a heating oven under an inert atmosphere (or in an oxidizing atmosphere, to be discussed shortly). The oven temperature is raised past the melting point of the polymer (about 130-140 degree C. for UHMWPE) and increased further until the thermal energy is sufficiently high to break C—C crosslinks induced by radiation in the material (equation (12)). The practical temperature range in which crosslink breakage is active in UHMWPE is about between 160 and 400 degree C.

As discussed earlier, beyond 400 degree C., the reaction rate for C—C backbone breakage occurs so rapidly that material deterioration accompanied by vigorous gas release and weight loss becomes undesirable (see U.S. patent application Ser. No. 11/463,423). The inventor discovered that once crosslinks are broken into alkyl free radicals, the latter have the tendency to migrate along the C—C backbone of UHMWPE with the help of heat (equation (13)). Migration of free radicals is accomplished by a known process called “hydrogen hopping” where a hydrogen atom jumps to combine with a neighboring free radical resulting a position switch between the two components (see for example “Radiation Chemistry of Polymers—Encyclopedia, Polymer Science and Technology”, David J. T. Hill and Andrew K. Whittaker, Copyright © 2004 by John Wiley & Sons, Inc.). It is a natural tendency for the material as a system to transform into the most stable and uniform state, provided that the activation energy for transformation is supplied. Note that thermal energy is a continuous, uniform field in contrast to radiation energy which is comprised of discrete photons or electrons, as discussed earlier. The inventor theorized that given sufficient time under a sufficiently high temperature, free radicals will re-distribute uniformly throughout the material. If an oxidizing atmosphere (such as air, oxygen, pressurized oxygen, or other oxidizing agents) is used during the heating step, then the oxidizing atmosphere must be replaced with an inert or oxygen-reduced atmosphere. At this time, cooling is initiated in the oven under an inert atmosphere to bring the oven temperature down to a temperature below the crystallization temperature range of the polymer (such as between 80 and 120 degree C. for UHMWPE) and then down to room temperature. During cooling, all free radicals react with neighboring counterparts via backbone migration to form crosslinks (equation (14)). At the same time, the polymer re-crystallizes into a solid. The inventor discovered that the resultant polymer contains uniform crosslinking and exhibit superior material properties (tensile, toughness, wear, etc,). Again, the control of crystallinity or density can be done to some extent by varying the cooling rate through the crystallization temperature range, as discussed earlier.

### Re-Connection of Broken Short Chains

As discussed earlier, if a C—C link in the backbone of a polymer is bombarded by a radiation source (gamma rays or electron beams), a chain rupture may occur. Chain scission can also occur during the post-radiation storage through oxidative reactions (equation (7)), as discussed earlier. When two chain rupture events occur on the same molecule within a short distance, a short chain is created. A higher radiation dose in general produces a higher amount of short chains, as evidenced by molecular weight analysis focusing on low molecular weight fractions (see for example in “Ultrahigh molecular weight polyethylene as used in articular prostheses (a molecular weight distribution study)”; Aldo M. Crugnola, Eric L. Radin, Robert M. Rose, Igor L. Paul, Sheldon R. Simon, Mark B. Berry; Journal of Applied Polymer Science, Volume 20, Issue 3, Pages 809-812). Molecular weight of short chains can be as low as a few thousands as compared to several millions in a regular UHMWPE. Some very short chains become gases and escape off the polymer matrix. Most broken short chains recrystallize utilizing the loosely packed space in the amorphous phase. Re-crystallization occurs at room or a low temperature and raises the overall crystallinity and density of the material. At the same time, tensile properties, toughness, and wear resistance are lowered, as discussed earlier.

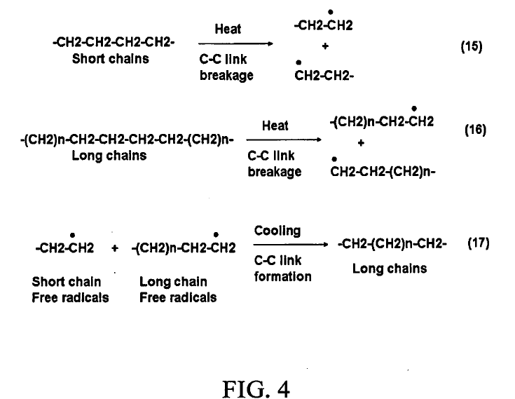

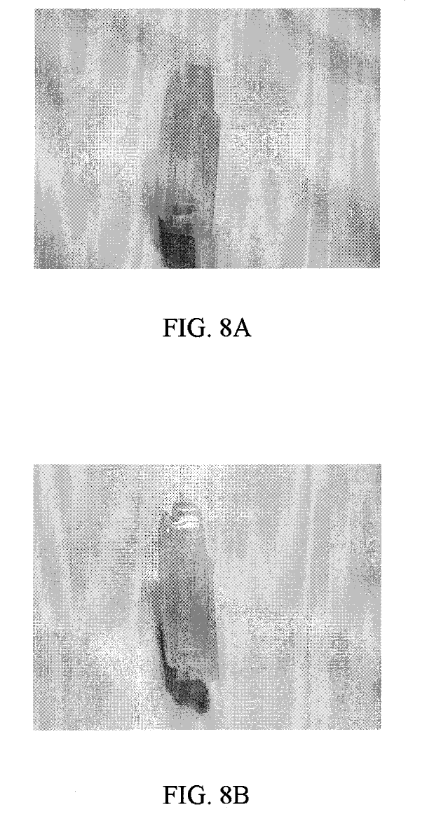

The inventor has discovered a method to re-connect these short chains with the polymer bulk matrix so that lost material properties can be restored. First, the irradiated polymer is placed in a heating oven under an inert atmosphere (or in an oxidizing atmosphere which is then replaced with an inert atmosphere prior to cooling). The oven temperature is raised past the melting temperature of the polymer material. The inventor discovered that the crystals originated from broken short chains melt in a lower temperature range of about 80 to 120 degree C., while the crystals of regular UHMWPE melt in the range of about 120-140 degree C. In certain circumstances, melting of the irradiated UHMWPE as analyzed by a thermal analyzer (such as DSC) occurs continuously in the range of 80 to 140 degree C. with a single melting peak (see Example 1, FIG. 8(b) in this application). In other circumstances, two or even three melting peaks are observed in the same temperature range (see Example 1, FIG. 8(a) for double peaks in this application; also see U.S. Pat. No. 6,786,933 for three peaks), indicating the existence of multiple crystalline morphologies in the material. The inventor discovered that in a temperature range just above the melting temperature range of the polymer (such as 140 to 160 degree. C for irradiated UHMWPE), not only all crystals are melted, polymer chains also gain sufficient thermal energy to move around via Brownian motions. The inventor further discovered that significant mixing between short and long chains takes place in the melt given sufficient thermal energy and time. After significant mixing has occurred, cooling is initiated in the oven under an inert atmosphere to bring the oven temperature down to a temperature below the crystallization temperature range of the polymer (such as between 80 and 120 degree C. for UHMWPE) and then down to room temperature. During cooling, short and long polymer chains, now well mixed, crystallize simultaneously. As a result, a homogeneous, chain folded morphology (crystalline regions inter-connected by amorphous tie molecules) is obtained. When this cooled is material is analyzed by DSC, a single melting peak is observed (see Example 1, FIG. 8(b) in this application), indicating a single crystalline morphology. While the above heating and cooling steps effectively remove the short chain phase from the irradiated material with lost material property recovered to some extent, the inventor discovered that no chemical bond connection exists between the broken short chains and the regular UHMWPE matrix in such treated material. In other words, short chains, while well mixed with long chains, still exist in the material. It is advantageous to eliminate short chains in the material to improve the material property. In order to achieve chemical bonding between short chains and long chains (UHMWPE), the inventor discovered that the heating step described above must be conducted at a temperature between about 160 and 400 degree C. where the thermal energy is sufficiently high to break some C—C links in the short as well as the long chains in the material, as shown in equation (15) of FIG. 4.

In equations of FIG. 4, (CH2)n is used to represent a long chain segment. As C—C links are broken by thermal force, short chain free radicals originated from short chains and long chain free radicals from regular UHMWPE are produced (equations (15) and (16) respectively). The inventor discovered that more C—C links are broken if a higher temperature or a longer time (or both) is used. After significant amount of C—C links are broken, cooling is initiated in the oven under an inert atmosphere to bring the oven temperature down to a temperature below the crystallization temperature range of the polymer (such as between 80 and 120 degree C. for UHMWPE) and then down to room temperature. During cooling, all free radicals (short and long) react with each other to form long polymer chains. The short chains no longer exist in the material after the cooling step. The inventor noticed the production of small amount of gases by the material during the heating and cooling steps which escape into the gas phase. As discussed earlier, beyond 400 degree C., the reaction rate for C—C link breakage occurs so rapidly that material deterioration accompanied by vigorous gas release and weight loss becomes undesirable (see U.S. patent application Ser. No. 11/463,423). Again, the control of crystallinity or density can be done to some extent by varying the cooling rate through the crystallization temperature range, as discussed earlier. As discussed above, while physical mixing of short chains with long chains can re-gain some lost material property, chemical bonding via free radical generation and re-combination (equations (15) through (17)) is a preferred method as it further improves material property.

### Formation of Thermally Induced Free Radicals and Crosslinks

The three reaction mechanisms just disclosed above (namely elimination of oxidation, breakage of existing crosslinks followed by free radical and crosslink re-distribution, and re-connection of broken short chains) all involve a heating and a cooling step. Furthermore, the effective or preferred temperature for all the heating steps fall in a range of between about 160 and 400 degree C. U.S. patent application Ser. No. 11/463,423 already disclosed that free radicals are produced in UHMWPE (and other poly-olefins) by thermal force in this temperature range. U.S. patent application Ser. No. 11/463,423 also disclosed that those thermally induced free radicals are re-combined into crosslinks in the subsequent cooling step. The inventor discovered that the same reactions occur in UHMWPE whether the polymer is virgin (non-irradiated) or previously irradiated. The inventor also discovered that this observation is true whether the polymer is in the form of a resin powder or a consolidated solid form (rods, slabs, blocks, etc.). In summary, formation of thermally induced free radicals and crosslinks occurs concurrently with the above described three mechanisms during the heating and cooling steps of an irradiated polymer. Furthermore, the is inventor discovered that a polymer structure consisting of both radiation-induced and thermal-induced crosslinks is desirable for enhanced material property, as explained in the next sections.

### Molecular Structural Difference in Radiation and Thermally Crosslinked Polymers

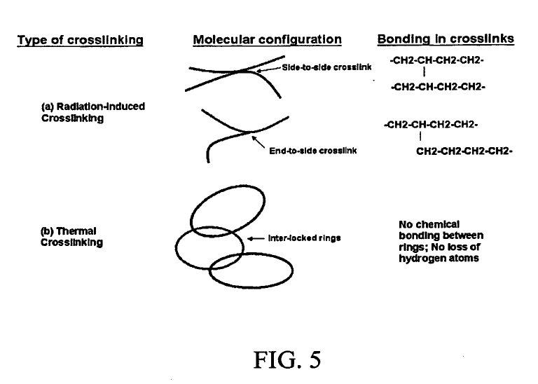

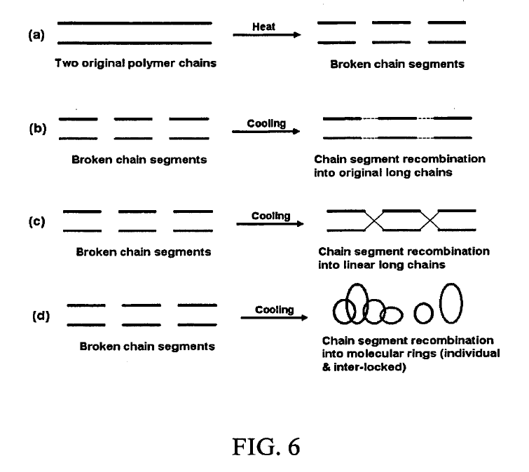

The inventor discovered a unique difference in molecular structure between radiation-induced crosslinking and thermal-induced crosslinking. For radiation-induced crosslinking, C—C crosslinks are created primarily by side-to-side or end-to-side covalent bonds between neighboring molecules as illustrated in FIG. 5(a). In the side-to-side crosslinking, hydrogen atoms as side groups are knocked off previously by radiation to create alkyl free radicals on the backbone that subsequently react in a paired fashion (FIG. 5(a)). In the end-to-side crosslinking, an alkyl free radical at chain end produced by C—C backbone scission reacts with another alkyl free radical (which loses a hydrogen atom previously) at a location other than chain ends (FIG. 5 (a)). In contrast, the inventor theorizes that thermal crosslinking consists primarily of two or multiple inter-locked molecular rings (FIG. 5 (b)). Individual molecular rings are formed when the two chain-end alkyl free radicals (created via C—C backbone scission by thermal force) of the same chain segment react with each other (FIG. 6(d)). Inter-locked rings are formed when two or more than two molecular rings cross into each other (FIG. 6(d)). There is no chemical bonding between inter-locked rings and there is no loss of hydrogen in either ring structure from the original polymer. More precisely, these crosslinks are physical in nature. As disclosed in U.S. patent application Ser. No. 11/463,423, hydrogen is hardly dissociated from the polymer structure during the heating step and thus the formation of side-to-side or end-to-side crosslinks is rare in thermal crosslinking. In addition to inter-locked rings, the inventor discovered that linear long polymer chains (similar to those existing in the virgin polymer) can also be formed during chain segment recombination, as shown in FIGS. 6(b) and 6(c). Long chains will form if broken chain segments created in the heating step (FIG. 6(a)) recombine with each other in a linear manner. There will be no crosslinking in the material if all chain segments react in a linear manner. Note that in FIG. 6(b), all chain segments originated from the same long chains recombine with each other to return to their original configurations. In FIG. 6(c), some crossing of recombination between two long chains occurs, but only chain entanglement, rather than “permanent” crosslinking, is created. The inventor first discovered that due to the extremely long chain length in the virgin polymer (up to several millions in molecular weight, or several hundred of thousands of carbon atoms per polymer chain, in the case of UHMWPE), the number of broken chain segments produced by the heating step is also extremely high (hundreds to thousands). It is well-known that the microstructure of a polymer in the molten state resembles “spaghetti”. It can be pictured that broken chain segments by thermal force are well mixed in the “spaghetti” and change their molecular configurations constantly and freely under high temperature conditions. During cooling, chain segments go through hundreds or thousands of recombination events until all free radicals are eliminated. It is noted that the majority of broken chains carry two free radicals at chain ends (except for those containing the original chain ends of the original molecules; they carry a single free radical). When reacting with each other in a series of combination, a ring structure must be formed at some point to eliminate even-numbered free radicals. Only chain segments that carry a single free radical will participate in the formation of linear molecules during recombination which involves odd-numbered free radicals. As a result, the likelihood of forming interlocked rings during cooling is very high. In contrast, the likelihood of forming linear long chains (FIGS. 6(b) and 6(c)) or individual molecular rings (FIG. 6(d)) is very low.

Extraction of polyethylene in a bath of hot or boiling xylene has been a common method used to determine the extent of crosslinking (see for example ASTM D2765). The “sol” phase (non-crosslinked portion) in the material will be extracted out while the “gel” phase (crosslinked portion) will stay intact upon xylene tests. Just like chemical crosslinking induced by radiation, the inventor discovered that polymers with thermal crosslinking hardly dissolve in boiling or hot xylene. The inventor discovered that both types of crosslinking treatments produce a significant amount of “gel” phase due to a 3-D inter-connected molecular network (up to 90-100% gel fraction). However, there are distinct features associated with each type of crosslinking, as discovered by the inventor. First, covalent bonds in chemical crosslinking are short (in the order of angstroms) and rigid. The polymer structure in chemically crosslinked regions is significantly stronger in material strength than that in non-crosslinked regions which consists of molecules held together by chain entanglements and weak van der Waals forces. As disclosed earlier, irradiated polymers produced by prior arts contain crosslinks that are not evenly distributed. Thus, upon tensile, compressive, shear, or multiple-stress loading, the polymer will rupture first in the non-crosslinked regions, causing the entire material to fail. Depending on the degree of crosslinking and loading conditions, chemical crosslinks might not rupture at all in these tests. It is noted that using the method disclosed in this application, uniform crosslinking can be obtained in irradiated polymers and the material weakness is eliminated. In physical crosslinking, as a strong contrast, the connection between interlocked rings is loose and non-rigid. Ring structures can be stretched to a great extent without causing material stiffness. As disclosed in U.S. patent application Ser. No. 11/463,423, a uniform thermal field can produce a polymer with uniform crosslinking. Thus, polymers with physical crosslinking in general tend to show superior elongation-at-break and fracture toughness than those with chemical crosslinking. In fact, some thermally crosslinked polymers exhibit a higher elongation-at-break and a higher tensile toughness than a virgin, non-crosslinked counterpart (see Example 6 in U.S. patent application Ser. No. 11/463,423 and Example 3 of this application). Conceivably, the 3-D molecular network created by interlocked rings in these thermally crosslinked polymers (but not in the virgin polymer) contributes to the observed material strength improvement. For orthopedic implant applications, wear resistance is a major concern. In general, a wear particle is produced at a joint implant under a cyclic loading when a small amount of polymer material is compressed, sheared, stretched, and finally broken off the polymer matrix. Due to (1) heavy, multiple stresses that often exceed the material strength, (2) fast-changing load directions, and (3) localized forces, some chemical crosslinks are believed to be ruptured in irradiated polymers upon a wear test or in actual clinical applications. Similarly, some molecular rings in thermally crosslinked polymers are believed to be cleaved open with wear debris produced. The inventor discovered that under these circumstances, both the degree of crosslinking (that is, the amount of crosslinks) and the distribution of crosslinks in the polymer are major factors for wear resistance. It has been established in literature that as the degree of crosslinking is increased, tensile or fracture toughness is decreased but the wear resistance is enhanced. Very often, material toughness and wear resistance are found to be two conflicting requirements in prior arts. Owing to uniform crosslinking (either physical or chemical), the inventor discovered that the conflict is lessened or completely eliminated using the methods taught in U.S. patent application Ser. No. 11/463,423 as well as in this application. The inventor further discovered that significant loss of tensile or fracture toughness is not observed until an extremely high degree of crosslinking is reached in an evenly crosslinked polymer. Such a high degree of crosslinking is often unnecessary as the wear rate already reaches a negligible level (or considered insignificant for clinical applications) at a lower degree of crosslinking.

It is noted that some authors consider chain entanglement (FIG. 6(c)) as a type of physical crosslinking; Some other authors consider weak attraction or hydrogen bonding between neighboring molecules as a type of physical crosslinking. The inventor defines “physical crosslinking” strictly as “inter-locked molecular rings” throughout this patent application. The inventor acknowledges that chain entanglement between molecules (FIG. 6(c)) is beneficial for material strength, although the linkage is not as strong as inter-locked rings. The inventor further acknowledges that thermally crosslinked polymer may contain a small amount of highly entangled chains. It is also noted that chain-folded, two-phase morphology (crystalline and amorphous) exists in the solid state of the virgin, radiation crosslinked, or thermally crosslinked polymer.

Creation of Chemical Crosslinking without Radiation

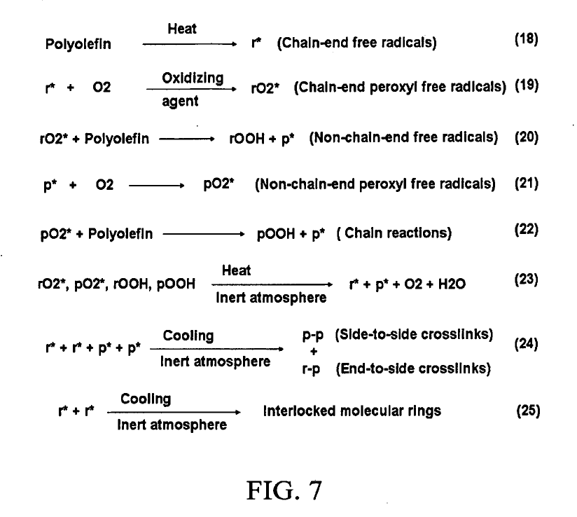

In prior arts, chemical crosslinking is either created by radiation (gamma rays or electron beams) or a chemical crosslinking agent (see for example in U.S. Pat. No. 6,281,264 for chemical crosslinking agents). The inventor discovered that chemical crosslinking can also be created without using radiation or a chemical crosslinking agent, but instead using thermal force with the help of an oxidizing agent. The method involves a serious of chemical reactions as described in equations (18) through (24) of FIG. 7.

In the first step, the polymer is placed in a heating oven at a temperature sufficiently high to break C—C bonds (such as between about 160 to 400 degree C. for UHMWPE as disclosed in U.S. patent application Ser. No. 11/463,423) and produce chain-end alkyl free radicals (Equation (18)). In the second step, an oxidizing agent, such as oxygen, is introduced into the oven. Introduction of an oxidizing agent can also be done during heating in the first step. The most convenient and low cost oxidizing atmosphere is air which contains about 20% oxygen. But, other oxidizing agents, such as pure oxygen, pressurized oxygen, ozone, fluorine, chlorine, peroxides, hypochlorites, chlorates, or persulfuric acid can also be used. An easy-to-remove oxidizing agent is in general preferred as it will not leave any chemical compound in the material after the crosslinking treatment (see the oxygen removal step discussed shortly). Using oxygen as an example, chain-end alkyl free radicals will react with oxygen to form peroxyl free radicals (equation (19)). The inventor discovered that for UHMWPE an oven temperature in the range of between about 160 and 400 degree C. is suitable for the reaction described in equation (19) to occur. As stated earlier, beyond 400 degree C., the reaction rate for C—C link breakage occurs so rapidly that material deterioration accompanied by vigorous gas release and weight loss becomes undesirable (see U.S. patent application Ser. No. 11/463,423). Within the temperature range cited, the oxygenation reaction rate (equation (19)) is very rapid. A dynamic equilibrium between oxygenation and de-oxygenation is soon established. The inventor discovered that a longer time is needed (a few minutes to a few hours) for oxygen to penetrate into the core of a thicker or larger polymer block. After the oxygenation reaction is complete, the oven temperature is cooled in the third step to a temperature in the range between room temperature and 160 degree C. for aging. This aging temperature is suitable for chemical reactions of equations (20) through (22) to occur. Equation (20) describes the reaction of a chain-end peroxyl free radical with polyolefin to form a peroxide and a non-chain-end free radical. Note that this reaction is the key for the formation of side-to-side or end-to-side chemical crosslinks in the subsequent reactions to be described shortly. Without oxygen attaching to it, the inventor discovered that a chain-end alkyl free radical produced by thermal force (equation (18)) is unable to react with a nearby hydrogen atom (a side group of polyethylene), and thus fails to generate a non-chain-end free radical. Once a non-chain-end free radical is formed, a series of chain reactions (equations (21) and (22)) take place to produce more non-chain-end free radicals (and peroxides). The inventor further discovered that oven temperature selection is important for this step. If a low aging temperature (such as room temperature) is used, reaction rates are low but more non-chain-end free radicals are produced given sufficient time (up to several days or months) as the oven condition favors the forward reactions of equations (20), (21), and (22). On the other end, if a high aging temperature (such as 160 degree C.) is used, reaction rates are high but less non-chain-end free radicals are produced, even given plenty of time as the oven condition favors the backward reactions of equations (20), (21), and (22). Thus, oven temperature and reaction time are two important factors that can be controlled to obtain the desired amount of non-chain-end free radicals and eventual chemical crosslinking. Once the third step is complete, oxygen is removed from the oven (by continuous nitrogen flush or vacuum suction). The oven temperature is raised again in the fourth step to a temperature between about 160 and 400 degree C. During this step, oxygen and peroxides are removed from the material in order to bring back alkyl free radicals (equation (23)). Note that oxygen and water released from the material during this step is removed continuously by nitrogen flush or vacuum suction provided in the oven. In the fifth step, the oven under inert (or non-oxidizing) atmosphere is cooled to room temperature. During this final step, chain-end and non-chain end free radicals react to form side-to-side or end-to-side crosslinks (equation (24)). Unlike radiation-induced chemical crosslinking in prior arts, the chemical crosslinks created here by thermal force with the help of oxygen is distributed uniformly on the micro-structural level due to a homogeneous (non-discrete) thermal field. As disclosed in U.S. patent application Ser. No. 11/463,423, some chain-end alkyl free radicals will also react to form interlocked polymer rings. As a result, the 5-step method taught here will result in a polymeric material containing both physical and chemical crosslinks. As stated earlier, the ratio of physical to chemical crosslinking can be controlled by the oven temperature and reaction time in the third step. Also, the inventor discovered that use of pure oxygen or pressurized oxygen (instead of room air with about 20% oxygen) will increase the reaction rate as well as the amount of chemical crosslinking in the material. During the fifth step of oven cooling, control of crystallinity or density of the resultant material can be done to some extent by varying the cooling rate through the crystallization temperature range, as discussed earlier.

### Combination of Thermal Crosslinking and Radiation Crosslinking

As disclosed in U.S. patent application Ser. No. 11/463,423 and this application, thermal force without the help of oxygen results in uniform physical crosslinking consisting of primarily interlocked molecular rings. With the help of oxygen (or other oxidizing agents), thermal force can produce a mixture of physical and chemical crosslinking all evenly distributed on a micro-structural level. In contrast, radiation in prior arts induces chemical crosslinking that is non-uniform on both macro- and micro-structural levels. A specific method is disclosed in this application which causes free radicals and crosslinks in a previously irradiated polymer to re-distribute, resulting in a polymer with uniform chemical crosslinking. In prior arts on radiation treatments, the amount of crosslinking is controlled by the radiation dose. A higher dose in general will give a higher level of crosslinking. Methods taught in U.S. patent application Ser. No. 11/463,423 and in this application also employ oven temperature, reaction time, or oxygen concentration (and pressure) as processing parameters for the control of (1) the amount of total crosslinking of any type, and (2) the ratio between physical and chemical crosslinking. The inventor discovered that physical crosslinking tends to increase the material's strength and toughness while chemical crosslinking at moderate to high levels has opposite effects. Furthermore, chemical crosslinking in general is a better molecular structure than physical crosslinking for wear resistance under heavy loading conditions. While chemical crosslinking can be created by either the thermal (with the help of oxygen) or radiation route, each has its own merits. In general, the thermal route takes a longer time (up to several days) to achieve the same degree of crosslinking but the distribution of crosslinks is uniform. The radiation route is very time-efficient (within minutes or hours) but the distribution of crosslinks is non-uniform. Re-distribution of non-uniform crosslinks in a previously irradiated polymer takes some time (within a day in general). From all the above findings, the inventor further discovered that a combination of thermal and radiation treatments is often highly desirable in order to obtain a target material in a timely manner at a low cost with a specific degree of crosslinking and a pre-determined ratio between physical and chemical crosslinking. Methods taught in U.S. patent application Ser. No. 11/463,423 and this application can be combined or alternated with a radiation treatment, such as in the following examples:

1. A virgin polymeric material is irradiated in air, followed by (a) elimination of oxidation, (b) breakage of existing crosslinks and free radical and crosslink redistribution, (c) short chain reconnection, and (d) creation of physical crosslinking, using methods taught in the application. Note that no inert atmosphere is needed for the radiation step as required in prior arts to avoid oxidation. The resultant material has the features of (a) containing no free radicals, (b) containing no oxidation products, (c) oxidation-free (short or long term), (d) improved wear resistance, and (e) enhanced, maintained or slightly decreased toughness compared to the virgin polymer (depending on the degree of chemical crosslinking).

2. A virgin polymeric material is physically crosslinked by thermal force without the help of an oxidizing agent, followed by radiation in air, and then followed by (a) elimination of oxidation, (b) breakage of existing crosslinks and free radical and crosslink redistribution, (c) short chain reconnection, and (d) creation of physical crosslinking, using methods taught in U.S. patent application Ser. No. 11/463,423 and this application. The resultant material has the features similar to one above.

3. A virgin polymeric material is irradiated in air, followed by thermal crosslinking with the help of pure oxygen to increase chemical crosslinking content, then followed by (a) elimination of oxidation, (b) breakage of existing crosslinks and free radical and crosslink redistribution, (c) short chain reconnection, and (d) creation of physical crosslinking, using methods taught in the application. Note that no inert atmosphere is needed for the radiation step as required in prior arts to avoid oxidation. The resultant material has the features similar to one above.

4. A virgin polymeric material is thermally crosslinked without the help of oxygen, followed by a second thermal crosslinking with the help of oxygen. The resultant material has the features of (a) containing no free radicals, (b) containing no oxidation products, (c) oxidation-free (short and long term), (d) improved wear resistance, and (e) enhanced, maintained or slightly decreased toughness (depending on the degree of chemical crosslinking). No radiation treatment is used for this example.

### INDUSTRIAL APPLICATIONS

While the methods disclosed so far (elimination of oxidation, breakage of existing crosslinks followed by free radical and crosslink re-distribution, re-connection of broken short chains, formation of thermally induced free radicals and crosslinks, creation of chemical crosslinking without radiation, and combination of thermal crosslinking and radiation crosslinking) can be used along or in any combination to produce useful and novel materials, some preferred methods and industrial applications will be described below.

### Using an Irradiated Solid Polymer as the Starting Material (Method A)

In the first preferred application (method A), a previously irradiated solid polymeric material such as UHMWPE, in the form of rods, slabs, or blocks, is obtained as the starting material for thermal crosslinking treatment. Irradiation can be gamma rays, electron beams, or other high energy radiation sources. Dose can vary from low to high. In the first step of the invention, the starting material is placed in a heating oven. Air and moisture can be reduced or removed from the interior of the oven at this point (Alternatively, air and moisture removal can be conducted just prior to cooling (to be described later)). This can be achieved by flushing the oven with an inert gas, such as nitrogen, argon, or helium, for a sufficient time (5 minutes or longer preferred). Alternatively, air and moisture can be removed by applying a vacuum (less than 2″ of mercury (50 torr) preferred) in the oven for a sufficient time (10 minutes or longer preferred). In the second step, heat is provided to raise the temperature in the oven to the pre-determined target temperature above the melting point of UHMWPE (at about 130 degree C.). The inventor discovered that rapid weight loss or de-polymerization, which is to be avoided in the present invention, occurs when the oven temperature exceeds about 400 degree C. Therefore, the preferred temperature range is between 140 and 400 degree C. A more preferred temperature range is between 160 and 350 degree C. for active free radicals and crosslinks formation without noticeable weight loss. It is in general desirable to raise the oven temperature slowly so that the temperature distribution in the oven interior as well as in the polymer solid is uniform. The preferred temperature variation in the polymer solid is less than 20 degree C. In the third step, the oven is maintained at the target temperature for a pre-determined time period. The preferred time period range is between 5 minutes and 24 hours for low temperature ranges of between 160 and 300 degree C.; and between 5 seconds and 2 hours for high temperature ranges of between 300 and 400 degree C. If air and moisture are not removed prior to heating, then they must be removed at this point (using the methods described above). In the fourth step, cooling is provided to bring the oven temperature back to room temperature or a temperature below the crystallization zone (about 80-120 degree C. for UHMWPE). Any known arts of cooling can be used. The preferred cooling method is by purging the oven with an inert gas, such as nitrogen, argon, or helium, for a sufficient time (20 minutes or longer preferred). Virtually all free radicals are eliminated in the cooling step. If a higher crystallinity is desirable, then a slower cooling rate is employed. The preferred cooling rate for high crystallinity is between 0.1 and 5 degree C. per minute. On the other hand, if a lower crystallinity is needed, then a faster cooling rate is used. The preferred cooling rate for low crystallinity is between 5 and 100 degree C. per minute. The preferred method for obtaining low crystallinity is quenching the crosslinked polymer melt in liquid nitrogen, dry ice, or ice-water. Using the above described four steps, a crosslinked, oxidation-free polyethylene having virtually non-detecting free radicals is produced. The resultant material contains a mixture of chemical and physical crosslinking. After a crosslinked polyethylene is obtained using the above four steps, implant manufacturers can follow the known arts to machine, drill, assemble, and package polyethylene implants. The last step in implant manufacturing, sterilization, can be done by known arts, such as ethylene oxide, hydrogen peroxide, gas plasma, or gamma radiation. Gamma radiation is the least preferred method of sterilization for the invention, since it adds new free radicals in polyethylene implants. If gamma radiation is used, the implants should be packaged in an oxygen-reducing atmosphere to avoid oxidation during storage. Other non-radiation methods are all suitable for sterilization of thermally crosslinked polyethylene implants.

### Using Irradiated Polymer Resin Powder as the Starting Material for Ram Extrusion or Compression Molding (Method B)

Implant material manufacturers often convert polymer resin powder into rods, slabs, blocks, or other solid forms using ram extrusion, compression molding, or other solid forming processes. Machining, drilling, and other fabrication steps are subsequently employed by implant manufacturers to obtain the final dimensions or shapes of the implant. Therefore, another preferred application of the invention is to create crosslinking in the solid forming step using irradiated polymer resin powder as the starting material. This preferred application includes the four similar steps described above in the Method A. All preferred processing and material property ranges are also identical between Methods A and B. Certain processing details for Method B are provided herein. In the first step, previously irradiated polymer resin powder is obtained as the starting material. Radiation can be done by gamma rays, electron beams, or other high energy radiation sources under air or inert atmosphere. Dose can vary from low to high. The resin powder is introduced into the receiving apparatus of the forming process (such as the material inlet in the ram extrusion or the mold cavity in the compression molding). Moisture and air in the polymer resin powder should be reduced or removed prior to the heating or the cooling step or the solid forming process, as discussed in Method A. Practical locations for air and moisture removal are (1) resin power storage container, (2) pre-heating zone or step, and (3) primary heating zone or step. Practical means of air and moisture removal include: (1) flushing with an inert gas, such as nitrogen, argon, or helium, for a sufficient time (longer than 5 minutes or continuously), (2) applying a vacuum (less than 2″ of mercury (50 torr) preferred) for a sufficient time (longer than 10 minutes, or continuously), (3) an escape path for air and moisture being provided in the forming process where high processing pressure and temperature conditions facilitate the diffusion of gases out of the material, and (4) a combination of (1), (2), and/or (3). Similar to Method A, heating and cooling means are provided in the solid forming process. If heating and cooling are provided along the solid forming path in a series of temperature zones (such as the pre-heating zone and subsequent heating and cooling zones in ram extrusion), it is important to ensure that the material is exposed to the target temperature (range) for a sufficient time to break existing crosslinks, re-distribute free radicals, re-connect broken short chains, and form new crosslinks. To eliminate oxidation from the material during cooling, the same methods used for air and moisture removal describe earlier should be used again during the cooling step or in the cooling zone. This step ensures that any oxygen-containing species in the material is completely removed. The total amount of crosslinks is controlled by the temperature profile along the solid forming path and the production (extrusion) rate. To completely fuse the resin powder, adequate pressure and temperature is needed in the solid forming process. The pressure itself does not create free radicals in polyethylene without the effect of elevated temperature. The temperature needed to break C—C links and create free radicals is in general higher than that needed for complete fusion of resin particles. Therefore, the target temperature for crosslinking is also suitable for complete fusion in most cases. Similar to Method A, if a lower crystallinity is desirable, a fast cooling rate can be used. Certain implant manufacturers require a high level of dimensional stability of polymer solids upon machining into final dimensions. In such cases, the cooling rate at the crystallization temperature zone (between 80 and 120 degree C. for UHMWPE) can still be set at a high value (such as 10 degree C. per minute) for obtaining normal to low crystallinity, but a post-forming annealing step at a temperature below the melting point (such as 110 degree C.) is recommended for increased dimensional stability.

### Using Irradiated Polymer Resin Powder as the Starting Material for Direct Compression Molding (Method C)

Another common process used by implant manufacturers converts the polymer resin powder into near-finished or finished products using compression molding in a single-step operation. The term “near finished product” refers to an inter-mediate product where the primary shape or dimension of the product has been achieved but certain minor product details (such as holes, flanges, etc.) are to be completed. Implant products made by this method include acetabular cups and tibial inserts in orthopedic applications. Fusion defects are less in general for this fabrication method working with a small volume of material, as compared to those in implants machined from rods, slabs, or blocks formed by ram extrusion or compression molding. Therefore, another preferred application (called Method C hereafter) of the invention is to create crosslinking in the compression molding step using irradiated polymer resin powder as the starting material. Method C includes the four similar steps described above in the Methods A and B. All preferred processing and material property ranges are also identical between Methods A, B, and C. Processing details are in general similar between Method C and the compression molding in Method B except that Method C works with a small volume while Method B with a large volume of material. Due to a smaller volume, temperature uniformity in the mold can be readily obtained in Method C. Cooling rate is also easier to control for the same reason. Since the final dimension of the product is formed in the compression mold (essentially no machining is followed post-molding), care must be taken to ensure that the required dimensions are obtained after the cooling step. Shrinkage of the material in the cooling step, which varies with cooling rate, must be taken into account.

Using Thermal Force with the Help of Air or Oxygen to Create Chemical Crosslinking (Method D; Supplemental)

Methods A, B, and C all use a previously irradiated polymer (being solid or resin powder) as the starting material to take advantage of chemical crosslinking created by radiation in the polymer. Alternatively, chemical crosslinking can be created by thermal force with the help of an oxidizing agent, as disclosed earlier in this patent application. To achieve this goal for each industrial application discussed above, some specific steps can be added or amended to the existing steps, as described below:
For Method A, the starting material is replaced with a non-irradiated polymer solid. The following steps are added prior to the heating step (the first step in Method A): (1) the starting material is placed in a heating oven continuously flushed with air, pure oxygen, or pressurized oxygen, (2) the oven temperature is raised to a pre-determined temperature above the melting point (such as between 160 and 400 degree C. for UHMWPE), (3) the oven temperature is held for a pre-set time period (such as minutes or hours), (4) the oven is cooled to a low temperature below the melting point (such as 50 to 120 degree C.) for aging, (5) the oven temperature is held for a pre-set time period (such as hours to days), and (6) the oven environment is converted from oxidizing (such as air, pure oxygen, or pressurized oxygen) to non-oxidizing (such as vacuum, nitrogen, or other inert atmosphere). Afterwards, the treatment continues with the heating and other steps described in Method A.
For Method B, the starting material is replaced with non-irradiated polymer resin powder. For compression molding, the following steps are added prior to the heating step (the first step in Method B): (1) the starting material placed in the mold is continuously flushed with air, pure oxygen, or pressurized oxygen, (2) the mold temperature is raised to a pre-determined temperature above the melting point (such as between 160 and 400 degree C. for UHMWPE), (3) the mold temperature is held for a pre-set time period (such as minutes or hours), (4) the mold is cooled to a low temperature below the melting point (such as 50 to 120 degree C.) for aging, (5) the mold temperature is held for a pre-set time period (such as hours to days), and (6) the mold environment is converted from oxidizing (such as air, pure oxygen, or pressurized oxygen) to non-oxidizing (such as vacuum, nitrogen, or other inert atmosphere). Note that all the additional steps are conducted with little compressive pressure. Afterwards, the treatment process continues with the heating and other steps described in Method B. For ram extrusion, the required additional steps are similar to those cited in compression molding, but the compression mold is replaced with a pre-heating zone (or pre-treatment zone) in the ram extrusion.
For Method C, the starting material is replaced with non-irradiated polymer resin powder. All additional steps are identical to those used for compression molding in Method B.

### Definition of Oven Environment

In the discussion of methods disclosed in U.S. patent application Ser. No. 11/463,423 and this application, the environment in the oven is an important factor. The inventor would like to provide a comprehensive definition of the three types of oven environment cited in both applications:

1. Oxidizing atmosphere: a gas phase that contains at least one oxidizing agent (also called an oxidant or oxidizer). An oxidizing agent is defined as a chemical compound that readily transfers oxygen atoms or a substance that gains electrons in a redox chemical reaction. The most convenient and low cost oxidizing atmosphere is air which contains about 20% oxygen. But, other oxidizing agents, such as ozone, fluorine, chlorine, peroxides, hypochlorites, chlorates, and persulfuric acid can also be used. An oxidizing agent is different from a chemical crosslinking agent in that the latter in general decomposes into free radicals to initiate crosslinking reactions, while the former does not prod ice free radicals itself but relies on other mechanisms of free radical generation for crosslinking reactions.

2. Inert or oxygen-reducing atmosphere: a gas phase that contains primarily non-reactive species, such as vacuum, nitrogen, argon, helium, and other oxygen-reducing environments.

3. Sensitizing atmosphere: a gas phase that contains a significant amount of non-oxidizing but reactive species, such as acetylene, hydrogen, ethylene, or hydrogen peroxide, etc.; this in general can be substituted when inert atmosphere is called for without affecting the general effects for methods disclosed in U.S. patent application Ser. No. 11/463,423 and this application

### Secondary Processes or Treatment

There are several known processes that have been used for improvement of polymeric materials. These include ultrasound, infrared, microwave, mechanical deformation, uni-directional drawing, bi-axial drawing, orientation, electromagnetic field, addition of a free radical scavenger (such as vitamin E), etc. However, none of the above cited processes or alike can act alone to create noticeable amount of free radicals in the polymeric material: Subsequently, significant crosslinking can not be created using any of these known processes alone. None of the above cited processes or alike can act alone to break existing crosslinks in the material for uniform redistribution. Therefore, a combination of any of these known arts with a thermal means taught by the invention for the purpose of creating uniform physical or chemical crosslinking, is deemed part of the invention.

### Purpose of Examples

It is to be understood that the description, specific examples and test data, while indicating exemplary aspects, are merely illustrative of the principles and applications and are not intended to limit the present invention. Various is changes and modifications within the present invention will become apparent to the skilled artisan from the discussion, disclosure and data contained herein, and thus are considered part of the invention as defined by the appended claims.

### EXAMPLES

### Example 1

### Effect of Elimination of Oxidation and Thermal Crosslinking (Visual Effect and DSC Thermal Analysis)

### Objective

This example demonstrates the method of oxidation elimination and thermal crosslinking and investigates the effect on both material appearance and thermal/molecular properties.

### Material and Method

An orthopedic tibial (knee) insert made of a ram extruded surgical grade UHMWPE was gamma irradiated at about 150 KGY in air and shelf aged in room air for 7 years.

The tibial insert was cut into two halves to reveal its interior. One of the two sections was chosen for the experiment. A photo picture was taken before treatment. A small piece of the material (about 10 mg in weight) was removed from the section and analyzed by DSC (differential scanning calorimetry) for melting characteristics.

Heating rate was set at 10 degree C./min. Afterwards, the same section was treated with the following steps:

(1) The insert was placed in a heating oven flushed continuously with nitrogen.

(2) The oven temperature was raised to 250 degree C. and held for 30 minutes.

(3) The oven temperature was cooled at about 1 degree C./min continuously to room temperature.

(4) The insert was taken out of oven.

A photo picture of the treated insert was taken. Again, a small piece of the material (about 10 mg in weight) was removed from the treated section and analyzed by DSC for melting characteristics.

### Result and Discussion

Photos taken before and after treatment are shown in FIG. 8.

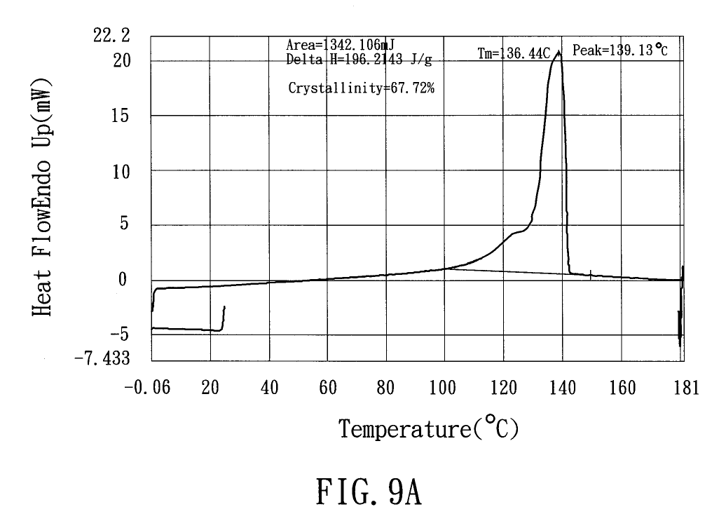

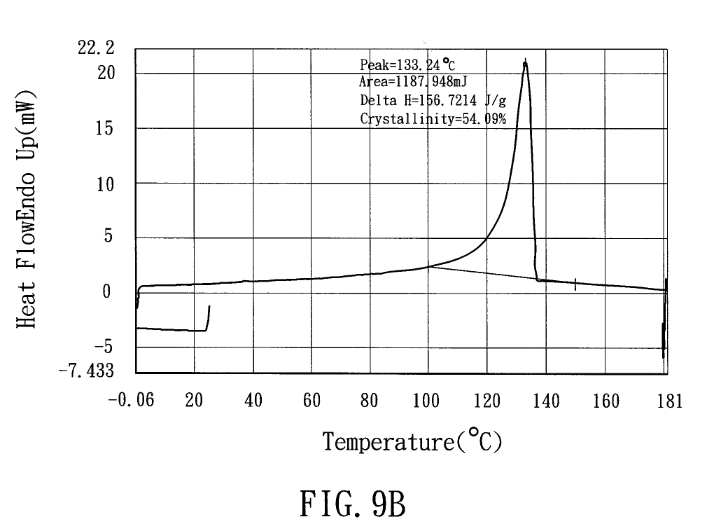

Before treatment, the insert showed stress whitening (FIG. 8(a)). Close examination revealed a sub-surface white band due to severe oxidation, similar to those white bands reported in literature (see for example D. C. Sun, C. Stark, J. H. Dumbleton, “The Origin of the White Band Observed in Direct Compression Molded UHMWPE Inserts”, paper presented at the 20th Annual Meeting of the Society For Biomaterials, page 121, 1994, Boston, Mass.). In general, stress whitening occurs during cutting when the material is brittle. As shown in FIG. 8(b), the stress whitening disappeared completely after the oxidation elimination step, an indication of successful oxidation removal. Furthermore, when the treated insert was cut again, no stress whitening was observed. DSC curves are shown in FIG. 9.

From FIG. 9(a), the untreated insert showed a major melting peak at about 139 degree C. with a second peak (shoulder) at about 123 degree C. As well known to polymer scientists, the second peak, appearing at a lower temperature than the major peak, is in general an indication of smaller crystallites formed from low molecular weight fractions. These small crystallites must be formed as the material is oxidized during radiation and post-radiation shelf storage. In contrast, the treated insert showed a sharp single peak at about 133 degree C., indicating a single homogeneous morphology. The DSC result indicates that not only the oxidation is eliminated, the broken short chains by radiation and oxidation are reconnected into the polymer matrix. As a result of (a) oxidation elimination and (b) short chain reconnection, the crystallinity was decreased from 68% before treatment to 54% after treatment. 54% crystallinity is close to normal values (50 to 60%) reported in literature for the virgin UHMWPE. In conclusion, thermal crosslinking treatment taught in the invention successfully removed stress whitening (oxidation) and short chains in the gamma irradiated and shelf aged UHMWPE. As a result, melting characteristics and crystallinity were restored.

### Example 2

### Effect of Oxidation Elimination and Thermal Crosslinking (Tensile Test)

### Objective

This example demonstrates the method of oxidation elimination and thermal crosslinking. It also investigates the effect on tensile property.

### Material and Method

A compression molded slab of surgical grade 1020 UHMWPE was gamma irradiated at about 50 KGY in air and shelf aged in room air for 13 months. A section of the slab was taken for tensile tests (before thermal treatment). Another section was treated with the following steps:

(1) The section was placed in a heating oven with continuously vacuum suction.

(2) The oven temperature was raised to 270 degree C. and held for 120 minutes.

(3) The oven temperature was cooled at about 1 degree C./min to room temperature.

(4) The section was taken out of oven.

After the treatment, the section was used for tensile tests (after thermal treatment). A universal testing machine (Instron, Model 4468) was employed to conduct tensile tests. Sample preparation and test procedures followed ASTM D638. Type-IV specimen configuration at thickness of 1-mm was used. The crosshead speed was set at 2-inch per minute.

### Result and Discussion

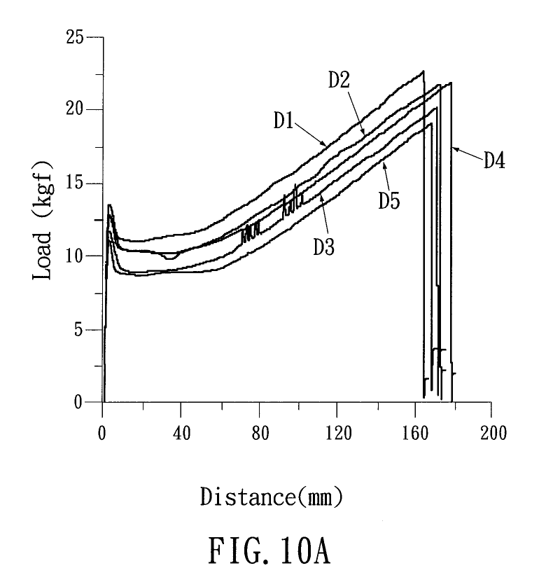

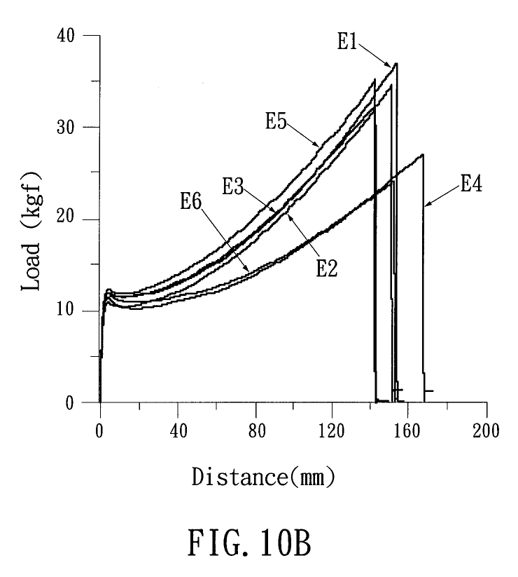

Load-extension curves are shown in FIGS. 10(a) and 10(b).

From the load-extension curve measured before treatment (FIG. 10(a)), a flat portion right after the yielding point was observed. This phenomenon is known to material scientists and is associated with “necking” of the test specimen. Necking is often observed during a tensile test when the material has inferior strength. In contrast, the treated specimens showed no necking. It is noted that virgin UHMWPE polymers do not neck during a tensile test. The results indicate that material weakness was introduced in the material before treatment due to radiation and oxidation. The results also indicate that material weakness was eliminated by the steps of thermal crosslinking. Tensile properties calculated from load-extension curves are shown in Table 1.

TABLE 1
Tensile results of UHMWPE gamma irradiated at
50KGY and shelf aged for 13 months

| | Tensile | Ultimate | | |
|---|---|---|---|---|
| | yield | tensile | | Fracture |
| Sample | strength, | strength, | Elongation | toughness, |
| ID | MPa | MPa | at break, % | Mpa |
| Before | 21 | 35 | 460*** | 122*** |
| thermal | | | | |
| treatment | | | | |
| After | 20 | 55 | 585 | 180 |
| thermal | | | | |
| treatment | | | | |

***Values adjusted to remove the effect of necking.

From Table 1, tensile yield strength was similar between two conditions (before or after treatment). However, the treatment steps effectively raised the values of ultimate tensile strength (56% increase), elongation at break (27% increase), and fracture toughness (47% increase). The results demonstrate a combined positive effect of (1) oxidation elimination and (2) thermal crosslinking on tensile property of a previously irradiated and shelf aged UHMWPE.

### Example 3

### Tensile Tests for Thermally Crosslinked UHMPWE

### Objective

This example investigates tensile property for various thermally crosslinked UHMWPE.

### Material and Method

A universal testing machine (Instron, Model 4468) was employed to conduct tensile tests. Sample preparation and test procedures followed ASTM D638. Type-IV specimen configuration at thickness of 1-mm (six specimens per sample) was used. The crosshead speed was set at 2-inch per minute. Five samples were tested with their preparation methods described below:

Sample A: Control. Virgin polymer of a surgical grade 1050 UHMWPE compression molded

Sample B: Physical crosslinking via thermal crosslinking. Using Sample A as the starting material, it was thermally crosslinked with the following steps:

(1) The sample was placed in a heating oven with continuously vacuum suction.

(2) The oven temperature was raised to 250 degree C. and held for 150 minutes.

(3) The oven temperature was cooled at about 1 degree C./min (average) to room temperature.

Sample C: Physical and chemical crosslinking via thermal crosslinking with the help of room air. Using Sample A as the starting material, it was thermally crosslinked with the following steps:

(1) The sample was placed in a heating oven with continuously flushed room air.

(2) The oven temperature was raised to 250 degree C. and held for 150 minutes.

(3) The oven temperature was cooled at about 1 degree C./min (average) to 80 degree C. The oven was kept at 80 degree C. under room air for 6 days.

(4) Room air was removed from the oven. Nitrogen was introduced into oven and flushed continuously. Oven temperature was raised to 250 degree C. and held for 150 minutes.

(5) The oven temperature was cooled at about 1 degree C./min to room temperature.

Sample D: Physical and chemical crosslinking via gamma radiation and thermal crosslinking. Using Sample A as the starting material, it was gamma irradiated in air at about 50 KGY (shelf aging less than 3-days). It was then thermally crosslinked with the following steps:

(1) The sample was placed in a heating oven with continuously vacuum suction.

(2) The oven temperature was raised to 250 degree C. and held for 150 minutes.

(3) The oven temperature was cooled at about 1 degree C./min (average) to room temperature.

Sample E: Physical and chemical crosslinking via gamma radiation and thermal crosslinking. Using Sample A as the starting material, it was gamma irradiated in air at about 75 KGY (shelf aging less than 3-days). It was then thermally crosslinked with the following steps:

(1) The sample was placed in a heating oven with continuously vacuum suction.

(2) The oven temperature was raised to 250 degree C. and held for 150 minutes.

(3) The oven temperature was cooled at about 1 degree C./min (average) to room temperature.

### Result and Discussion

Averaged tensile properties calculated from load-extension curves are shown in Table 2.

TABLE 2
Tensile results of thermally crosslinked
UHMWPE

| | | Tensile | Ultimate | | |
|---|---|---|---|---|---|
| | | yield | tensile | Elongation | Frature |
| Sample | | strength, | strength, | at | toughness, |
| ID | Treatment | MPa | MPa | break, % | MPa |
| A | Untreated | 21 | 43 | 390 | 109 |
| B | Thermal | 23 | 45 | 542 | 162 |
| | crosslinking | | | | |
| | (physical) | | | | |
| C | Thermal | 21 | 55 | 547 | 183 |
| | crosslinking | | | | |
| | (physical | | | | |
| | and | | | | |
| | chemical) | | | | |
| D | Air | 19 | 50 | 427 | 137 |
| | irradiated | | | | |
| | @50 KGY; | | | | |
| | Thermal | | | | |
| | crosslinking | | | | |
| E | Air | 19 | 41 | 345 | 95 |
| | irradiated | | | | |
| | @75 KGY; | | | | |
| | Thermal | | | | |
| | crosslinking | | | | |
| ASTM | Industrial | 19-21 | 27-35 | 250-300 | Not |
| F648 | standard | (mini- | (mini- | (minimum) | specified |
| | for | mum) | mum) | | |
| | surgical | | | | |
| | grade | | | | |
| | UHMWPE | | | | |

From Table 2, tensile yield strength was similar for all five samples (ranging from 19 to 23 MPa). Three invention examples (Sample B with purely physical crosslinking, Sample C with a mixture of chemical and physical crosslinking without radiation, and Sample D irradiated in air at 50 KGY followed by thermal crosslinking) exhibited higher ultimate tensile strength, elongation at break, and fracture toughness compared to the virgin polymer. The results are in strong contrast to those reported in prior arts where radiation crosslinking in general weakens tensile properties. When the radiation dose was increased to 75 KGY for the other invention example (Sample E; irradiated in air at 75 KGY followed by thermal crosslinking), tensile properties (ultimate tensile strength, elongation at break, and fracture toughness) were lowered slightly from those of the virgin polymer. Example 3 demonstrates that thermal crosslinking methods taught in the invention in general improve, maintain, or reduce slightly toughness-related tensile properties. Noticeable adverse effects of crosslinking on toughness are seen only when the amount of chemical crosslinking approaches a very high level (as induced by a high dose radiation). Note that tensile properties of Sample E still meets ASTM F648 industrial standard for a surgical grade virgin UHMWPE (see Table 2). Example 3 along with Example 7 for wear results (to be discussed later) further demonstrates that optimization is now made possible by the invention for obtaining a low wear, high toughness polymeric material.

### Example 4

### Gel Content, Swell Ratio, and DSC for Thermally Crosslinked UHMPWE

### Objective

This example demonstrates various methods of thermal crosslinking (physical and chemical) on both unirraidated and irradiated UHMWPE. It also investigates the effect of thermal crosslinking on gel content, swell ratio, and DSC melting characteristics.

### Material and Method

Procedures listed in ASTM D 2765 (Standard Test Methods for Determination of Gel Content and Swell Ratio of Crosslinked Ethylene Plastics) were followed to determine the gel content in UHMWPE. Briefly, to obtain gel content, a polymer sample placed in a stainless pouch was immersed in boiling xylene for 12 hours. Following solvent extraction and drying, gel content (insoluble or crosslinked portion, %) was determined by dividing the dried weight with the original sample weight. Thin plates (about 0.5-1.0 mm thick) cut from a surgical grade 1050 UHMWPE slab produced by compression molding were used. Sample weights were kept at between 0.5 and 0.6 g. To obtain swell ratio, procedures were similar to those used for gel content, except that xylene extraction took place at 110 degree C. for 24 hours and that the weight of the wet, swollen sample (taken right after the xylene bath) was needed additionally for the calculation. DSC was also used to determine melting point and crystallinity. Heating rate was set at 10 degree C./min. Samples evaluated include:

Sample A: Control. Virgin polymer of a surgical grade 1050 UHMWPE compression molded

Sample B: Physical crosslinking via thermal crosslinking. Using Sample A as the starting material, it was thermally crosslinked with the following steps:

(1) The sample was placed in a heating oven with continuously vacuum suction.

(2) The oven temperature was raised to 250 degree C. and held for 150 minutes.

(3) The oven temperature was cooled at about 1 degree C./min (average) to room temperature.

Sample C: Physical and chemical crosslinking via thermal crosslinking with the help of room air. Using Sample A as the starting material, it was thermally crosslinked with the following steps:

(1) The sample was placed in a heating oven with continuously flushed room air.

(2) The oven temperature was raised to 250 degree C. and held for 150 minutes.

(3) The oven temperature was cooled at about 1 degree C./min (average) to 80 degree C. The oven was kept at 80 degree C. under room air for 6 days.

(4) Room air was removed from the oven. Nitrogen was introduced into oven and flushed continuously. Oven temperature was raised to 250 degree C. and held for 150 minutes.

(5) The oven temperature was cooled at about 1 degree C./min to room temperature.

Sample D: Physical and chemical crosslinking via thermal crosslinking with the help of pure oxygen. Using Sample A as the starting material, it was thermally crosslinked with the following steps:

(1) The sample was placed in a heating oven with continuously flushed pure oxygen (about 99%)

(2) The oven temperature was raised to 250 degree C. and held for 150 minutes

(3) The oven temperature was cooled at about 1 degree C./min (average) to 80 degree C. The oven was kept at 80 degree C. under pure oxygen (industrial grade; 99.99%) for 6 days

(4) Pure oxygen was removed from the oven. Nitrogen was introduced into oven and flushed continuously. Oven temperature was raised to 250 degree C. and held for 150 minutes

(5) The oven temperature was cooled at about 1 degree C./min to room temperature

Sample E: Chemical crosslinking via gamma radiation. Using Sample A as the starting material, it was gamma irradiated in air at about 25KGY (shelf aging less than 3-days).

Sample F: Physical and chemical crosslinking via gamma radiation and thermal crosslinking. Using Sample E as the starting material, it was thermally crosslinked with the following steps:

(4) The sample was placed in a heating oven with continuously vacuum suction

(5) The oven temperature was raised to 250 degree C. and held for 150 minutes

(6) The oven temperature was cooled at about 1 degree C./min (average) to room temperature

### Result and Discussion

Gel content, swell ratio, melting peak temperature, and crystallinity results are tabulated in Table 3:

TABLE 3
Gel content, swell ratio, melting peak temperature,
and crystallinity results of UHMWPE following thermal
crosslinking

| | | | | Melting | |
|---|---|---|---|---|---|
| | | Gel | Swell | peak, | |
| Sample | Treatment | content, % | ratio | degree C. | Crystallinity, % |
| A | Control | 65 | 12.5 | 136 | 51 |
| | (untreated) | | | | |
| B | Thermal | 96 | 5.8 | 137 | 52 |
| | crosslinking | | | | |
| | (physical) | | | | |
| C | Thermal | 98 | 5.1 | 137 | 51 |
| | crosslinking | | | | |
| | (physical | | | | |
| | and | | | | |
| | chemical; | | | | |
| | using room | | | | |
| | air) | | | | |
| D | Thermal | 98 | 4.5 | 137 | 52 |
| | crosslinking | | | | |
| | (physical | | | | |
| | and | | | | |
| | chemical; | | | | |
| | using pure | | | | |
| | oxygen) | | | | |
| E | Radiation | 98 | 3.3 | 137 | 56 |
| | crosslinking | | | | |
| | (chemical) | | | | |
| F | Radiation | 100 | 2.4 | 137 | 52 |
| | and thermal | | | | |
| | crosslinking | | | | |
| | (physical | | | | |
| | and | | | | |
| | chemical) | | | | |

From Table 3, the virgin polymer (Sample A) had the lowest gel content (65%). All other crosslinked samples (Samples B through F) had a gel content close to or equal to 100%. The results indicate that both types of crosslinking (physical or chemical) can effectively create a 3-D molecular network that does not dissolve in boiling xylene. Again, the virgin polymer (Sample A) had the highest swell ratio (12.5), indicating the lowest crosslinking density. Sample B, with physical crosslinking only, had a swell ratio of 5.8, which is a great improvement for crosslinking density from the virgin polymer. Note that physical crosslinking is created by loose inter-locked rings, therefore the crosslinking density is inherently lower than that of chemical crosslinking formed by covalent bonds between molecules. When some chemical crosslinking was added to the material with the help of room air (Sample C), the swell ratio was further improved to 5.1. When room air (containing about 20% oxygen) was replaced with pure oxygen (Sample D), the swell ratio was lowered still to 4.5. Radiation crosslinking (Sample E) proved to be an effective means of chemical crosslinking. The swell ratio was 3.3 for Sample E. After thermal crosslinking of Sample E, the swell ratio was decreased to 2.4 for Sample F. The decrease in swell ratio here (i.e. increase in crosslinking density) is attributed to (1) residual free radicals in Sample E were now crosslinked in Sample F, (2) oxidation in Sample E (although at a low level without much shelf aging) was eliminated in Sample F, (3) broken short chains in Sample E were reconnected into the polymer matrix in Sample F, and (4) more crosslinks (physical) were created by thermal crosslinking. From DSC melting analysis, all samples showed a single melting peak at temperature between 136 and 137 degree C. Except for Sample E (gamma irradiated in air), all other samples showed a crystallinity ranging from 51 to 52%. Sample E had 56% crystallinity due to radiation damage (broken short chains and oxidation). The radiation damage was recovered in Sample F thanks to thermal crosslinking. The DSC results indicate that using thermal crosslinking methods taught in U.S. patent application Ser. No. 11/463,423 and in this application result in a new material, regardless of having physical, chemical, or combined crosslinking, that resemble the virgin polymer in the melting behavior. In contrast, radiation crosslinking used in prior arts (represented by Sample E in this example) in general causes an increase in crystallinity. In conclusion, thermal crosslinking methods taught in the invention produced polymeric materials with high gel content, low swell ratio, and similar melting temperature and crystallinity, compared to the virgin polymer.

### Example 5

### Free Radicals in Thermally Crosslinked UHMWPE

### Objective

This example measures free radical concentrations in thermally crosslinked UHMWPE.

### Material and Method

An ESR spectrometer was used to measure free radical concentrations in UHMWPE. Six samples specified in Example 3 were tested. All ESR tests were conducted at room temperature.

### Result and Discussion

Free radical concentrations are tabulated in Table 4:

TABLE 4
Free radical concentrations in thermally
crosslinked UHMWPE

| | | Free radical |
|---|---|---|
| | | concentration |
| Sample | Treatment | (10.sup. 15 spin/g) |
| A | Control | Undetectable* |
| | (untreated) | |
| B | Thermal | Undetectable* |
| | crosslinking | |
| | (physical) | |
| C | Thermal | Undetectable* |
| | crosslinking | |
| | (physical and | |
| | chemical; using | |
| | room air) | |
| D | Thermal | Undetectable* |
| | crosslinking | |
| | (physical and | |
| | chemical; using | |
| | pure oxygen) | |
| E | Radiation | 35 |
| | crosslinking | |
| | (chemical) | |
| F | Radiation and | Undetectable* |
| | thermal | |
| | crosslinking | |
| | (physical and | |
| | chemical) | |

Note:
the detection limit of free radical concentration (minimum level) for the ESR instrument is estimated at 1.0.times.10.sup.15 spin/gram.

From Table 4, it can be seen that the untreated control sample (Sample A) contained no free radicals. In contrast, gamma-ray irradiated Sample E showed a significant amount of free radicals (35×10.sup.15 spin/g). Furthermore, no free radicals were detected in any of the thermally crosslinked samples (Samples B, C, D, and F). It is concluded that the cooling step starting from a high temperature way above melting disclosed in the invention is effective for the recombination of free radicals after the heating and the holding steps.

### Example 6

### FTIR Oxidation Index in Thermally Crosslinked UHMWPE

### Objective

This example investigates the extent of oxidation in thermally crosslinked UHMWPE

### Material and Method

A FTIR (Fourier Transform infrared spectroscopy) spectrophotometer (Nicolet Avatar 320) was used to measure oxidation index in UHMWPE. Detailed procedures are listed in ASTM 2102. Briefly, oxidation index is defined as the ratio of the peak area at 1716 cm**−1 (carbonyl group) to the peak area at 1464 cm**−1 (methyl group). Six samples as specified in Example 3 in the form of thin films (about 200 microns) taken from the core of the treated slabs were analyzed by FTIR. To test the effect of aging, procedures listed in ASTM F2003 were employed. Briefly, Samples B, C, D, E, and F were aged in an air oven at 80 degree C. for 11 days and then analyzed again (designated as Sample B-aged, Sample C-aged, Sample D-aged, Sample E-aged, and Sample F-aged respectively).

### Result and Discussion

Oxidation indices are tabulated in Table 5:

TABLE 5
Oxidation index in thermally crosslinked UHMWPE

| Sample | Treatment | Oxidation index |
|---|---|---|
| A | Control | Below 0.01 |
| | (untreated) | |
| B | Thermal | Below 0.01 |
| | crosslinking | |
| | (physical) | |
| C | Thermal | Below 0.01 |
| | crosslinking | |
| | (physical and | |
| | chemical; using | |
| | room air) | |
| D | Thermal | Below 0.01 |
| | crosslinking | |
| | (physical and | |
| | chemical; using | |
| | pure oxygen) | |
| E | Radiation | 0.05 |
| | crosslinking | |
| | (chemical) | |
| F | Radiation and | Below 0.01 |
| | thermal | |
| | crosslinking | |
| | (physical and | |
| | chemical) | |
| B-aged | Sample B aged in | Below 0.01 |
| | air oven at 80 | |
| | degree C. for 11 | |
| | days | |
| C-aged | Sample C aged in | Below 0.01 |
| | air oven at 80 | |
| | degree C. for 11 | |
| | days | |
| D-aged | Sample D aged in | Below 0.01 |
| | air oven at 80 | |
| | degree C. for 11 | |
| | days | |
| E-aged | Sample E aged in | 0.08 |
| | air oven at 80 | |
| | degree C. for 11 | |
| | days | |
| F-aged | Sample F aged in | Below 0.01 |
| | air oven at 80 | |
| | degree C. for 11 | |
| | days | |

From Table 5, it can be seen that the starting untreated sample (Sample A) was oxidation-free. It can also be seen that radiation crosslinking causes Sample F to contain a low level of oxidation (oxidation index 0.05). Upon accelerated aging, the oxidation index increased to 0.08. All thermally crosslinked samples, fresh or aged showed no sign of oxidation (Samples B, C, D, F, B-aged, C-aged, D-aged, and F-aged). Since ESR results in Example 4 showed Samples B, C, D, and F to contain no free radicals, it comes no surprise that superior oxidation resistance was observed for these four materials. It is concluded that thermal crosslinking steps disclosed in the invention produces UHMWPE material with short and long term oxidation resistance.

### Example 7

### Wear Test of Thermally Crosslinked UHMWPE

### Objective

This example investigates the effect of thermal crosslinking on wear resistance

### Material and Method

The wear test follows the guideline given in ASTM F732-00. Briefly, a 6-station pin-on-flat wear-machine was used where linear reciprocating wear motion was applied to a sliding pair between the UHMWPE specimen (13 mm long and 9 mm in diameter) and the counter face Co—Cr—Mo alloy. A constant loading stress (3.45 MPa) was applied with the sliding speed at 50 mm/s. Lubrication was accomplished by using a filter-sterilized bovine serum diluted with DI water (up to 75 volume %). Wear rate, in terms of weight loss, was measured every 0.5 million cycles. All specimens were presoaked for at least 20 days in the lubricant solution prior to testing. Cleaning and drying of UHMWPE specimens was conducted according to ASTM F2025 (Annex A6). Five UHMWPE samples were tested:

Sample A: control (virgin polymer, surgical grade UHMWPE untreated)

Sample B: Using Sample A as the starting material, it was gamma irradiated in nitrogen at 50 KGY followed by inert annealing at 100 degree C. to crosslink free radicals in the amorphous regions

Sample C: Using Sample A as the starting material, it was gamma irradiated in nitrogen at 100 KGY followed by inert annealing at 100 degree C. to crosslink free radicals in the amorphous regions

Sample D: Using Sample A as the starting material, it was gamma irradiated in air at 50 KGY followed by the next treatment steps:

(1) The sample was placed in a heating oven with continuously vacuum suction

(2) The oven temperature was raised to 250 degree C. and held for 150 minutes

(3) The oven temperature was cooled at about 1 degree C./min (average) to room temperature

Sample E: Using Sample A as the starting material, it was gamma irradiated in air at 75 KGY followed by the next treatment steps:

(1) The sample was placed in a heating oven with continuously vacuum suction

(2) The oven temperature was raised to 250 degree C. and held for 150 minutes

(3) The oven temperature was cooled at about 1 degree C./min (average) to room temperature

### Result and Discussion

Wear loss-test cycle curves are presented in FIG. 10. Average wear rates are tabulated in Table 6.

TABLE 6
Average wear rates at 5-MM cycle for crosslinked
UHMWPE

| | | Wear rate |
|---|---|---|
| Sample ID | Treatment | (mg/million cycle) |
| A | Untreated | 3.4 |
| B | Gamma irradiated | 2.1 |
| | in nitrogen at 50 | |
| | KGY; inert | |
| | annealed at 100 | |
| | degree C. | |
| C | Gamma irradiated | 1.5 |
| | in nitrogen at 100 | |
| | KGY; inert | |
| | annealed at 100 | |
| | degree C. | |
| D | Gamma irradiated | 1.2 |
| | in air at 50 KGY; | |
| | thermally | |
| | crosslinked at 250 | |
| | degree C. | |
| E | Gamma irradiated | 0.5 |
| | in air at 75 KGY; | |
| | thermally | |
| | crosslinked at 250 | |
| | degree C. | |

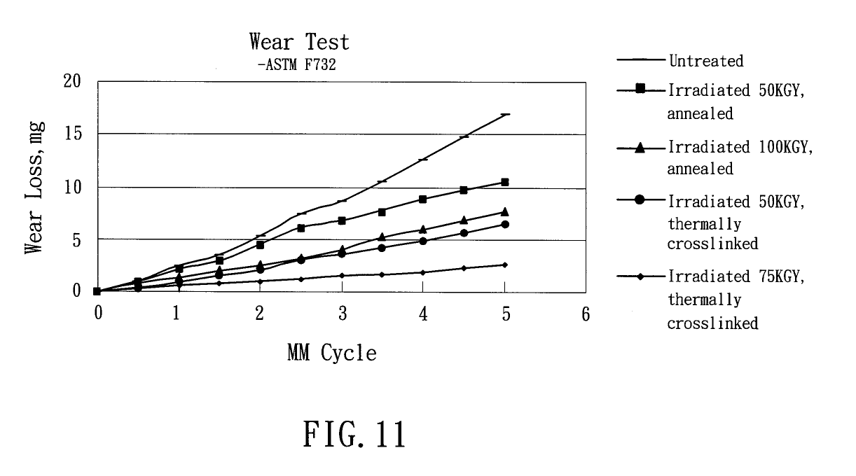

From FIG. 11 and Table 6, the untreated control had the highest wear rate (3.4 mg/million cycle). Gamma radiation at 50 KGY followed by annealing (prior arts) reduced the wear rate to 2.1 mg/million cycle (Sample B). At a higher dose of 100 KGY (prior arts), gamma radiation followed by annealing further reduced the wear rate to 1.5 mg/million cycle (Sample C). Note that these two irradiated samples (Samples B and C) still contained residual free radicals that would oxidize upon exposure to air or oxidizing environments. Sample D was gamma irradiated in air at 50 KGY (a dose that was identical to Sample B and lower than Sample C) followed by thermal crosslinking. Its wear rate (1.2 mg/million cycle) was lower than either Sample B or Sample C. Sample E (gamma irradiated at 75 KGY in air followed by thermal crosslinking) had the lowest wear rate (0.5 mg/million cycle) among all samples. The wear improvement in Samples D or E was attributed to (1) no residual free radicals, (2) uniform distribution of crosslinks, (3) no broken short chains, and (4) additional crosslinks by thermal crosslinking (physical). The wear rate reduction reached 85% for Sample E using the virgin polymer as the control. The wear rate of 0.5 mg/million cycle (or about 0.54 mm**3/million cycle based upon a density value of 0.93 g/cc) for Sample E has reached a negligible level for clinical considerations. Example 7 along with Example 3 for tensile properties discussed earlier (Table 2) demonstrates that methods and processing conditions taught by the invention can be optimized to obtain a low wear, high toughness polymeric material.

What is claimed is:

1. A method for producing a polymeric material formed from an olefinic compound, the material having significant crosslinking and improved oxidation resistance comprising the steps of:
(a) irradiating the polymeric material;
(b) heating said irradiated polymeric material in (a) for a predetermined time at a predetermined temperature sufficiently high to (i) remove oxygen from the material, (ii) break existing crosslinks generated by said radiation in (a), (iii) redistribute free radials generated by said radiation in (a) uniformly in the microstructure, (iv) redistribute free radicals produced by said crosslink breakage in (ii) uniformly in the microstructure, (v) reconnect broken short chains generated by said radiation in (a) with unbroken long molecules, and (vi) create new free radicals by thermal force by breaking carbon-carbon links in the microstructure; and
(c) cooling the irradiated and heated polymeric material in an oxygen reduced atmosphere from said temperature to eliminate free radicals and form crosslinks in the polymer microstructure.

2. The method as claimed in claim 1, wherein said heating and cooling steps are repeated.

3. The method as claimed in claim 1, wherein said polymeric material is ultra high molecular weight polyethylene having a molecular weight of at least 400,000.

4. The method as claimed in claim 1, wherein said irradiation is by means of gamma rays or electron beams and is conducted in air, oxidizing atmosphere, or inert atmosphere.

5. The method as claimed in claim 1, wherein said heating is conducted in air, oxidizing atmosphere, or inert atmosphere; said predetermined temperature is between 140 degree C. and 400 degree C.; and said predetermined time is between 5 seconds and 24 hours.

6. The method as claimed in claim 1, wherein said oxygen reduced atmosphere contains no more than 2% oxygen and is made up of an inert gas selected from the group consisting of nitrogen, helium, argon, and a combination thereof, or a vacuum of less than 2 inches of mercury, or a sensitizing environment made up of a gas selected from the group consisting of acetylene, ethylene, hydrogen, and a combination thereof

7. The method as claimed in claim 1, wherein said cooling is conducted at a slow rate of about 1 degree C. per minute or at a fast rate by quenching in ice-water.

8. The method as claimed in claim 1, wherein said cooled polymeric material in (c) having predetermined degree of crosslinking and ratio of chemical crosslinking to physical crosslinking is obtained by adjust said radiation dose and said heating temperature or said heating time.

9. A method for producing a polymeric material formed from an olefinic compound, the material having significant crosslinking and improved oxidation resistance comprising the steps of:
(a) heating the polymeric material for a predetermined time at a predetermined temperature sufficiently high to break carbon-carbon links, generate free radicals, and form cross-links in the polymer micro-structure;
(b) cooling said heated polymeric material in (a) from said temperature in (a) to eliminate free radicals and form crosslinks in the polymer micro-structure.
(c) irradiating said cooled polymeric material in (b);
(d) heating said irradiated polymeric material in (c) for a predetermined time at a predetermined temperature sufficiently high to (i) remove oxygen from the material, (ii) break existing crosslinks generated by said radiation in (c), (iii) redistribute free radials generated by said radiation in (c) uniformly in the microstructure, (iv) redistribute free radicals produced by said crosslink breakage in (ii) uniformly in the microstructure, (v) reconnect broken short chains generated by said radiation in (c) with unbroken long molecules, and (vi) create new free radicals by thermal force by breaking carbon-carbon links in the microstructure; and
(e) cooling said irradiated and heated polymeric material in (d) in an oxygen reduced atmosphere from said temperature to eliminate free radicals and form crosslinks in the polymer microstructure.

10. The method as claimed in claim 9, wherein said polymeric material is ultra high molecular weight polyethylene having a molecular weight of at least 400,000.

11. The method as claimed in claim 9, wherein said irradiation is by means of gamma rays or electron beams and is conducted in air, oxidizing atmosphere, or inert atmosphere.

12. The method as claimed in claim 9, wherein said heating in (a) or (d) and said cooling in (b) are conducted in air, oxidizing atmosphere, or inert atmosphere; said predetermined temperature is between 140 degree C. and 400 degree C.; and said predetermined time is between 5 seconds and 24 hours.

13. The method as claimed in claim 9, wherein said oxygen reduced atmosphere contains no more than 2% oxygen and is made up of an inert gas selected from the group consisting of nitrogen, helium, argon, and a combination thereof, or a vacuum of less than 2 inches of mercury, or a sensitizing environment made up of a gas selected from the group consisting of acetylene, ethylene, hydrogen, and a combination thereof

14. The method as claimed in claim 9, wherein said cooling is conducted at a slow rate of about 1 degree C. per minute or at a fast rate by quenching in ice-water.

15. The method as claimed in claim 9, wherein said cooled polymeric material in (e) having predetermined degree of crosslinking and ratio of chemical crosslinking to physical crosslinking is obtained by adjust said radiation dose and said heating temperature or said heating time.

16. A method for producing a polymeric material made from a olefinic compound, the material having significant crosslinking and improved oxidation resistance comprising the steps of:
(a) irradiating the polymeric material;
(b) aging said irradiated polymeric material in (a) in a heating device for a predetermined time at a predetermined temperature between room temperature and 140 degree C. in the presence of an oxidizing agent to create more free radicals and chemical crosslinks between neighboring molecules;
(c) heating said irradiated and aged polymeric material in
(b) for a predetermined time at a predetermined temperature sufficiently high to (i) break carbon-oxygen bonds in the material, (ii) break existing crosslinks generated by said radiation in (a), (iii) redistribute free radials generated by said radiation in (a) uniformly in the microstructure, (iv) redistribute free radicals produced by said crosslink breakage in (ii) uniformly in the microstructure, (v) reconnect broken short chains generated by said radiation in (a) with unbroken long molecules, and (vi) create new free radicals by thermal force by breaking carbon-carbon links in the microstructure; and
(d) cooling said heated polymeric material in (c) in an oxygen reduced atmosphere from said temperature in (c) to eliminate free radicals and form crosslinks in the polymer microstructure.

17. The method as claimed in claim 16, wherein said polymeric material is ultra high molecular weight polyethylene.

18. The method as claimed in claim 16, wherein said irradiation is by means of gamma rays or electron beams and is conducted in air, oxidizing atmosphere, or inert atmosphere.

19. The method as claimed in claim 16, wherein said heating is conducted in air, oxidizing atmosphere, or inert atmosphere; said predetermined temperature is between 140 degree C. and 400 degree C.; and said predetermined time is between 5 seconds and 24 hours.

20. The method as claimed in claim 16, wherein said oxygen reduced atmosphere contains no more than 2% oxygen and is made up of an inert gas selected from the group consisting of nitrogen, helium, argon, and a combination thereof; or a vacuum of less than 2 inches of mercury; or a sensitizing environment made up of a gas selected from the group consisting of acetylene, ethylene, hydrogen, and a combination thereof

21. The method as claimed in claim 16, wherein said cooling is conducted at a slow rate of about 1 degree C. per minute or at a fast rate by quenching in ice-water.

22. The method as claimed in claim 16, wherein said cooled polymeric material in (d) having predetermined degree of crosslinking and ratio of chemical crosslinking to physical crosslinking is obtained by adjust said radiation dose and said heating temperature or said heating time.

23. A method for producing a medical implant made from a solid olefinic material having a molecular weight of between 400,000 and 10,000,000 comprising the steps of:
(a) irradiating the solid polymeric material;
(b) placing said irradiated solid polymeric material in (a) in a heating device;
(c) heating said irradiated solid polymeric material in (a) for a predetermined time at a predetermined temperature sufficiently high to (i) remove oxygen from the material, (ii) break existing crosslinks generated by said radiation in (a), (iii) redistribute free radials generated by said radiation in (a) uniformly in the microstructure, (iv) redistribute free radicals produced by said crosslink breakage in (ii) uniformly in the microstructure, (v) reconnect broken short chains generated by said radiation in (a) with unbroken long molecules, and (vi) create new free radicals by thermal force by breaking carbon-carbon links in the microstructure;
(d) cooling said irradiated and heated polymeric material in (c) in an oxygen reduced atmosphere in said heating device to eliminate free radicals and form crosslinks in the microstructure; and
(e) fabricating the medical implant from said cooled polymeric material in (d).

24. The method as claimed in claim 23, wherein said polymeric material is ultra high molecular weight polyethylene.

25. The method as claimed in claim 23, wherein said irradiation is by means of gamma rays or electron beams and is conducted in air, oxidizing atmosphere, or inert atmosphere.

26. The method as claimed in claim 23, wherein said heating is conducted in air, oxidizing atmosphere, or inert atmosphere; said predetermined temperature is between 160 degree C. and 350 degree C.; and said predetermined time is between 5 seconds and 24 hours.

27. The method as claimed in claim 23, wherein said oxygen reduced atmosphere contains no more than 2% oxygen and is made up of an inert gas selected from the group consisting of nitrogen, helium, argon, and a combination thereof; or a vacuum of less than 2 inches of mercury; or a sensitizing environment made up of a gas selected from the group consisting of acetylene, ethylene, hydrogen, and a combination thereof

28. The method as claimed in claim 23, wherein said cooling is conducted at a slow rate of about 1 degree C. per minute or at a fast rate by quenching in ice-water.

29. The method as claimed in claim 23, wherein said fabricating step is machining, drilling, patterning, fashioning, polishing, assembling, or a combination thereof.

30. The method as claimed in claim 23, wherein said fabricated medical implant in (e) having predetermined degree of crosslinking and ratio of chemical crosslinking to physical crosslinking is obtained by adjust said radiation dose and said heating temperature or said heating time.

31. A method for producing a medical implant made from a powder olefinic material having a molecular weight of between 400,000 and 10,000,000 comprising the steps of:
(a) irradiating the powder polymeric material;
(b) placing said irradiated powder polymeric material in (a) in a forming device;
(c) heating said irradiated powder polymeric material in (a) for a predetermined time at a predetermined temperature sufficiently high to (i) remove oxygen from the material, (ii) break existing crosslinks generated by said radiation in (a), (iii) redistribute free radials generated by said radiation in (a) uniformly in the microstructure, (iv) redistribute free radicals produced by said crosslink breakage in (ii) uniformly in the microstructure, (v) reconnect broken short chains generated by said radiation in (a) with unbroken long molecules, and (vi) create new free radicals by thermal force by breaking carbon-carbon links in the microstructure;
(d) forming the solid polymeric material from said irradiated and heated powder polymeric material in (c) in an oxygen reduced atmosphere in said forming device by simultaneously applying sufficient pressure and heat followed by cooling from said temperature into a solid material to eliminate free radicals and form crosslinks in the microstructure; and
(e) fabricating the medical implant from said cooled solid olefinic material in (d).

32. The method as claimed in claim 31, wherein said powder olefinic material is resin powder of ultra high molecular weight polyethylene.

33. The method as claimed in claim 31, wherein said forming device is ram extrusion or compression molding.

34. The method as claimed in claim 31, wherein said irradiation is by means of gamma rays or electron beams and is conducted in air, oxidizing atmosphere, or inert atmosphere.

35. The method as claimed in claim 31, wherein said heating is conducted in air, oxidizing atmosphere, or inert atmosphere; said predetermined temperature is between 160 degree C. and 350 degree C.; said predetermined time is between 5 seconds and 24 hours; and said pressure is between 6.9 MPa (1000 psi) and 69 MPa (10,000 psi).

36. The method as claimed in claim 31, wherein said oxygen reduced atmosphere contains no more than 2% oxygen and is made up of an inert gas selected from the group consisting of nitrogen, helium, argon, and a combination thereof, or a vacuum of less than 2 inches of mercury, or a sensitizing environment made up of a gas selected from the group consisting of acetylene, ethylene, hydrogen, and a combination thereof

37. The method as claimed in claim 31, wherein said cooling is conducted at a slow rate of about 1 degree C. per minute or at a fast rate by quenching in ice-water.

38. The method as claimed in claim 31, wherein said fabricating step is machining, drilling, patterning, fashioning, polishing, assembling, or a combination thereof

39. The method as claimed in claim 31, wherein said fabricated medical implant in (e) having predetermined degree of crosslinking and ratio of chemical crosslinking to physical crosslinking is obtained by adjust said radiation dose and said heating temperature or said heating time.

40. A method for producing a perform or nearly finished shape of a medical implant made from a powder olefinic material having a molecular weight of between 400,000 and 10,000,000 comprising the steps of:
(a) irradiating the powder polymeric material;
(b) placing said irradiated powder polymeric material in (a) in the cavity of a compression mold;
(c) heating said irradiated powder polymeric material in said mold cavity in (b) for a predetermined time at a predetermined temperature sufficiently high to (i) remove oxygen from the material, (ii) break existing crosslinks generated by said radiation in (a), (iii) redistribute free radials generated by said radiation in (a) uniformly in the microstructure, (iv) redistribute free radicals produced by said crosslink breakage in (ii) uniformly in the microstructure, (v) reconnect broken short chains generated by said radiation in (a) with unbroken long molecules, and (vi) create new free radicals by thermal force by breaking carbon-carbon links in the microstructure;
(d) forming the perform or near-finished shape of a medical implant from said irradiated and heated powder olefinic material in (c) in an oxygen reduced atmosphere in said mold cavity by simultaneously applying sufficient pressure and heat followed by cooling from said temperature into a solid material to eliminate free radicals and form crosslinks in the microstructure; and
(e) fabricating the medical implant from said cooled solid olefinic material in (d).

41. The method as claimed in claim 40, wherein the powder olefinic material is resin powder of ultra high molecular weight polyethylene.

42. The method as claimed in claim 40, wherein said irradiation is by means of gamma rays or electron beams and is conducted in air, oxidizing atmosphere, or inert atmosphere.

43. The method as claimed in claim 40, wherein said heating is conducted in air, oxidizing atmosphere, or inert atmosphere; said predetermined temperature is between 160 degree C. and 350 degree C.; said predetermined time is between 5 seconds and 24 hours; and said pressure is between 6.9 MPa (1000 psi) and 69 MPa (10,000 psi).

44. The method as claimed in claim 40, wherein said oxygen reduced atmosphere contains no more than 2% oxygen and is made up of an inert gas selected from the group consisting of nitrogen, helium, argon, and a combination thereof, or a vacuum of less than 2 inches of mercury, or a sensitizing environment made up of a gas selected from the group consisting of acetylene, ethylene, hydrogen, and a combination thereof.

45. The method as claimed in claim 40, wherein said cooling is conducted at a slow rate of about 1 degree C. per minute or at a fast rate by quenching in ice-water.

46. The method as claimed in claim 40, wherein said fabricating step is machining, drilling, patterning, fashioning, polishing, assembling, or a combination thereof.

47. The method as claimed in claim 40, wherein said fabricated medical implant in (e) having predetermined degree of crosslinking and ratio of chemical crosslinking to physical crosslinking is obtained by adjust said radiation dose and said heating temperature or said heating time.

48. A method for removing oxygen from a oxidized polymeric material formed from an olefinic compound, the material having improved oxidation resistance and restored material property comprising the steps of:
(a) placing the oxidized polymeric material in a heating device;
(b) heating said oxidized polymeric material in (a) for a predetermined time at a predetermined temperature sufficiently high to break carbon-oxygen bonds in the microstructure; and
(c) cooling said heated polymeric material in (b) in an oxygen reduced atmosphere from said temperature to eliminate free radicals and form crosslinks in the polymer microstructure.

49. The method as claimed in claim 48, wherein said olefinic polymeric material is ultra high molecular weight polyethylene.

50. The method as claimed in claim 48, wherein said olefinic polymeric material is previously irradiated.

51. The method as claimed in claim 48, wherein said olefinic polymeric material is a medical implant.

52. The method as claimed in claim 48, wherein said heating is conducted in air, oxidizing atmosphere, or inert atmosphere; said predetermined temperature is between 100 degree C. and 350 degree C.; and said predetermined time is between 5 seconds and 24 hours.

53. The method as claimed in claim 48, wherein said oxygen reduced atmosphere contains no more than 2% oxygen and is made up of an inert gas selected from the group consisting of nitrogen, helium, argon, and a combination thereof, or a vacuum of less than 2 inches of mercury, or a sensitizing environment made up of a gas selected from the group consisting of acetylene, ethylene, hydrogen, and a combination thereof.

54. The method as claimed in claim 48, wherein said cooling is conducted at a slow rate of about 1 degree C. per minute or at a fast rate by quenching in ice-water.

55. A method for producing a polymeric material formed from an olefinic compound, the material having significant chemical crosslinking and improved material property without radiation comprising the steps of:
(a) placing the polymeric material in a heating device;
(b) heating said polymeric material in the presence of an oxidizing agent for a predetermined time at a predetermined temperature sufficiently high to break carbon-carbon links in said polymeric material to create free radicals and chemical crosslinking between neighboring molecules;
(c) aging said heated polymeric material in (b) for a predetermined time at a predetermined temperature lower than said predetermined temperature in (b) in the presence of an oxidizing agent to create more free radicals and chemical crosslinking between neighboring molecules;
(d) replacing said oxidizing atmosphere in the heating device with a non-oxidizing atmosphere;
(e) heating said heated and aged polymeric material in (c) for a predetermined time at a predetermined temperature sufficiently high to break carbon-oxygen bonds in the microstructure; and
(f) cooling said heated polymeric material in (e) in an oxygen reduced atmosphere from said temperature in (e) to eliminate free radicals and form crosslinks in the polymer microstructure.

56. The method as claimed in claim 55, wherein said polymeric material is ultra high molecular weight polyethylene having a molecular weight of at least 400,000.

57. The method as claimed in claim 55, wherein said predetermined temperature in (b) and in (e) is between 140 degree C. and 400 degree C. and said predetermined time is between 5 seconds and 24 hours; said predetermined aging temperature in (c) is between room temperature and 140 degree C. and said predetermined time is between 5 hours and 10 days.

58. The method as claimed in claim 55, wherein said oxidizing atmosphere contains at least one oxidizing agent selected from air, oxygen, ozone, fluorine, chlorine, peroxides, hypochlorites, chlorates, or persulfuric acid.

59. The method as claimed in claim 55, wherein said non-oxidizing atmosphere or said oxygen reduced atmosphere contains no more than 2% oxygen and is made up of an inert gas selected from the group consisting of nitrogen, helium, argon, and a combination thereof, or a vacuum of less than 2 inches of mercury, or a sensitizing environment made up of a gas selected from the group consisting of acetylene, ethylene, hydrogen, and a combination thereof.

60. The method as claimed in claim 55, wherein said cooling is conducted at a slow rate of about 1 degree C. per minute or at a fast rate by quenching in ice-water.

61. The method as claimed in claim 55, wherein said cooled polymeric material in (f) having predetermined degree of crosslinking and ratio of chemical crosslinking to physical crosslinking is obtained by adjusting said heating temperature or heating time in (b); by adjusting said aging temperature or aging time in (c); or by adjusting said heating temperature or heating time in (e).
